(19) United States
(12) Patent Application Publication
(10) Pub. No.: US 2016/0371431 A1
(43) Pub. Date: Dec. 22, 2016

(54) METHODS OF PREDICTING PATHOGENICITY OF GENETIC SEQUENCE VARIANTS

(71) Applicant: Counsyl, Inc., South San Francisco, CA (US)

(72) Inventors: Imran Saeedul HAQUE, San Francisco, CA (US); Eric Andrew EVANS, Brisbane, CA (US); Sharad Mandyam VIKRAM, San Diego, CA (US); Matthew David RASMUSSEN, San Francisco, CA (US)

(21) Appl. No.: 15/189,957

(22) Filed: Jun. 22, 2016

Related U.S. Application Data
(60) Provisional application No. 62/183,132, filed on Jun. 22, 2015.
(60) Provisional application No. 62/221,487, filed on Sep. 21, 2015.
(60) Provisional application No. 62/236,797, filed on Oct. 2, 2015.

(51) Int. Cl. G06F 19/24; G06N 7/00; G06F 19/22

(52) U.S. Cl. CPC G06F 19/24; G06F 19/22; G06N 7/005

(57) ABSTRACT

Recent developments in cost-effective DNA sequencing allows for individualized genomic screening of a subject for genetic sequence variants. Training a pathogenicity prediction model using semi-supervised training methods produces a better model for predicting the pathogenicity of a test genetic sequence variant. Provided herein are methods for predicting the pathogenicity of a test genetic sequence variant by utilizing a training data set comprising labeled benign genetic sequence variants unlabeled genetic sequence variants, the unlabeled genetic sequence variants comprising a mixture of benign genetic sequence variants and pathogenic genetic sequence variants. The genetic sequences are annotated with one or more features and a machine learning model is trained in a semi-supervised process based on the training data. The test genetic sequence is then annotated using the one or more features and the probability that the test genetic sequence variant is pathogenic is predicted based on the trained machine learning model.

### CROSS-REFERENCE TO RELATED APPLICATIONS

This application claims priority benefit of U.S. Provisional Application No. 62/183,132 filed on Jun. 22, 2015; of U.S. Provisional Application No. 62/221,487 filed on Sep. 21, 2015; and of U.S. Provisional Application No. 62/236,797 filed on Oct. 2, 2015. The entire contents of each of these applications are hereby incorporated by reference herein.

### FIELD OF THE INVENTION

The following disclosure generally relates to predicting pathogenicity of genetic sequences and, more specifically, predicting pathogenicity of genetic sequence variants.

### BACKGROUND OF THE INVENTION

The advent of cost-effective DNA sequencing has provided clinics with high-resolution information about patient's genetic sequence variants, which has resulted in the need for efficient interpretation of this genomic data. Such testing provides patients with actionable information that allows them to understand their health risks and better plan their future treatment. Accordingly, more informative and available diagnostic testing promises to not only benefit patients, but also improve the efficiency of the health care system overall. Traditionally, genetic sequence variant interpretation has been dominated by many manual, time-consuming processes due to the disparate forms of relevant information in clinical databases and literature.

However, the high resolution of sequencing data poses the challenge of genetic sequence variant interpretation. It is likely that, in each patient, sequencing will reveal new genetic sequence variants and the clinician must determine if these newly-observed genetic sequence variants are likely to be pathogenic. These classifications drive all further risk calculations and medical counseling. Current standard methods of genetic sequence variant interpretation are based on a time-consuming, manual integration of multiple data sources, involving extensive database and literature searches, use of computational methods, and multiple rounds of review. Even still, this process rarely yields sufficient information to classify the genetic sequence variant as pathogenic or benign, requiring the curator to classify it as a variant of uncertain significance (VUS). VUS's can be a source of anxiety for patients who desire concrete results. Due to this additional burden on patients, reducing VUS classifications is a paramount concern.

The disclosures of all publications referred to herein are each hereby incorporated herein by reference in their entireties.

### SUMMARY OF THE INVENTION

Provided herein is a computer-implemented method for predicting pathogenicity of a test genetic sequence variant, the method comprising, at an electronic device having at least one processor and memory, receiving training data comprising a first data set comprising labeled benign genetic sequence variants, and a second data set comprising unlabeled genetic sequence variants, the unlabeled genetic sequence variants comprising a mixture of benign genetic sequence variants and pathogenic genetic sequence variants; annotating each genetic sequence variant in the first data set and the second data set with one or more features; training a machine learning model based on the training data, wherein the machine learning model is trained in a semi-supervised process; annotating the test genetic sequence variant with the one or more features; and predicting a probability that the test genetic sequence variant is pathogenic based on the machine learning model after training.

Further provided herein is a computer-implemented method for predicting pathogenicity of a test genetic sequence variant, the method comprising, at an electronic device having at least one processor and memory, receiving training data comprising a first data set comprising labeled benign genetic sequence variants, and a second data set comprising simulated genetic sequence variants, the simulated genetic sequence variants comprising an unlabeled mixture of benign genetic sequence variants and pathogenic genetic sequence variants; annotating each genetic sequence variant in the first data set and the second data set with one or more features; training a machine learning model based on the training data, wherein the machine learning model is trained in a semi-supervised process; annotating the test genetic sequence variant with the one or more features; and predicting a probability that the test genetic sequence variant is pathogenic based on the machine learning model after training.

Also provided is a computer-implemented method for predicting pathogenicity of a test genetic sequence variant, the method comprising, at an electronic device having at least one processor and memory, training a machine learning model based on training data, wherein the machine learning model is trained in a semi-supervised process, and the training data comprises a first data set comprising labeled benign genetic sequence variants, and a second data set comprising unlabeled genetic sequence variants, the unlabeled genetic sequence variants comprising a mixture of benign genetic sequence variants and pathogenic genetic sequence variants; wherein each variant in the first data set and the second data set is annotated with one or more features; annotating the test genetic sequence variant with the one or more features; and predicting a probability that the test genetic sequence variant is pathogenic based on the machine learning model after training.

Also provided is a computer-implemented method for predicting pathogenicity of a test genetic sequence variant, the method comprising, at an electronic device having at least one processor and memory, training a machine learning model based on training data, wherein the machine learning model is trained in a semi-supervised process, and the training data comprises a first data set comprising labeled benign genetic sequence variants, and a second data set comprising simulated genetic sequence variants, the simulated genetic sequence variants comprising an unlabeled mixture of benign genetic sequence variants and pathogenic genetic sequence variants; wherein each variant in the first data set and the second data set is annotated with one or more features; annotating the test genetic sequence variant with the one or more features; and predicting a probability that the test genetic sequence variant is pathogenic based on the machine learning model after training.

Also provided herein is a method for predicting pathogenicity of a test genetic sequence variant, the method comprising training a machine learning model based on training data, wherein the machine learning model is trained in a semi-supervised process, and the training data comprises a first data set comprising labeled benign genetic sequence variants and a second data set comprising unlabeled genetic sequence variants, the unlabeled genetic sequence variants comprising a mixture of benign genetic sequence variants and pathogenic genetic sequence variants, wherein each variant in the first data set and the second data set is annotated with one or more features; annotating the test genetic sequence variant with the one or more features; and predicting a probability that the test genetic sequence variant is pathogenic based on the machine learning model after training.

Also provided herein is a method for predicting pathogenicity of a test genetic sequence variant, a method for predicting pathogenicity of a test genetic sequence variant, the method comprising annotating the test genetic sequence variant with one or more features; and predicting a probability that the test genetic sequence variant is pathogenic based on a trained machine learning model, wherein the machine learning model is trained based on training data in a semi-supervised processes, and the training data comprises a first data set comprising labeled benign genetic sequence variants and a second data set comprising unlabeled genetic sequence variants, the unlabeled genetic sequence variants comprising a mixture of benign genetic sequence variants and pathogenic genetic sequence variants; wherein each genetic sequence variant in the first data set and the second data set are annotated with one or more features.

Further provided is a method for predicting pathogenicity of a test genetic sequence variant, the method comprising training a learning model based on training data, wherein the learning model is trained in a semi-supervised process, and the training data comprises a first data set comprising labeled benign genetic sequence variants, and a second data set comprising unlabeled genetic sequence variants, the unlabeled genetic sequence variants comprising a mixture of benign genetic sequence variants and pathogenic genetic sequence variants, wherein each variant in the first data set and the second data set is annotated with one or more features; annotating the test genetic sequence variant with the one or more features; and predicting a probability that the test genetic sequence variant is pathogenic based on the learning model after training.

Also provided is a method for predicting pathogenicity of a test genetic sequence variant, the method comprising annotating the test genetic sequence variant with one or more features; and predicting a probability that the test genetic sequence variant is pathogenic based on a trained learning model, wherein the learning model is trained based on training data in a semi-supervised processes, and the training data comprises a first data set comprising labeled benign genetic sequence variants, and a second data set comprising unlabeled genetic sequence variants, the unlabeled genetic sequence variants comprising a mixture of benign genetic sequence variants and pathogenic genetic sequence variants wherein each genetic sequence variant in the first data set and the second data set are annotated with one or more features.

In some embodiments, the method further comprises generating the training data. In some embodiments, the machine learning model comprises a generative model. In some embodiments, the generative model is a generative mixture model. In some embodiments, the generative model relies on one or more probability distributions specified by the one or more features. In some embodiments, the one or more features comprise conditionally independent probability distributions. In some embodiments, the one or more probability distributions comprise a plurality of nodes, the nodes comprising discrete features or continuous features, wherein the discrete features comprise a Dirichlet conditionally independent probability distribution and the continuous features comprise a Gaussian conditionally independent probability distribution. In some embodiments, the machine learning model comprises a discriminative model. In some embodiments, the machine learning model does not comprise a support vector machine.

In some embodiments, the semi-supervised process is performed by expectation-maximization. In some embodiments, the training comprises assigning each genetic sequence variant in the training data to a benign cluster or a pathogenic cluster. In some embodiments, the training comprises fixing one or more learning parameters for the benign clusters after n number of rounds of training and allowing one or more learning parameters for the pathogenic clusters to vary for (n+x) rounds of training; wherein n and x are positive integers. In some embodiments, the one or more learning parameters for the benign clusters are fixed after one round of training. In some embodiments, the benign cluster comprises a plurality of benign sub-clusters. In some embodiments, the pathogenic cluster comprises a plurality of pathogenic sub-clusters.

In some embodiments, the machine learning model assigns the test genetic sequence variant to a benign cluster or a pathogenic cluster. In some embodiments, the benign cluster comprises a plurality of benign sub-clusters. In some embodiments, the pathogenic cluster comprises a plurality of pathogenic sub-clusters.

In some embodiments, the labeled benign genetic sequence variants have an allele frequency greater than 90% in a selected population. In some embodiments, the unlabeled genetic sequence variants are simulated genetic sequence variants.

In some embodiments, the test genetic sequence variant is a human genetic sequence variant. In some embodiments, the test genetic sequence variant comprises a missense genetic sequence variant, a nonsense genetic sequence variant, a splice-site genetic sequence variant, an insertion genetic sequence variant, a deletion genetic sequence variant, or a regulatory element genetic sequence variant.

In some embodiments, the one or more features comprise a feature defined on an evolutionary conservation score, a missense variant score, an insertion variant score, a deletion variant score, a splice-site variant scores, or a regulatory score.

Further provided herein is a non-transitory computer-readable storage medium comprising computer-executable instructions for carrying out any of the methods described herein. Also provided is a system comprising one or more processors, memory, and one or more programs, wherein the one or more programs are stored in the memory and configured to be executed by the one or more processors, the one or more programs including instructions for carrying out any of the methods disclosed herein.

### BRIEF DESCRIPTION OF THE DRAWINGS

FIG. 1 illustrates an exemplary method for predicting pathogenicity of a test genetic sequence variant.

FIG. 2 depicts an exemplary computing system configured to perform any one of the methods of processes described herein.

FIG. 3 illustrates an exemplary machine learning model useful for the methods and systems described herein.

FIG. 4 illustrates one embodiment of a process using an expectation-maximization algorithm to train a generative machine learning model based on the genetic sequence variant data set as described herein.

FIG. 5A illustrates an exemplary method for training and testing a machine learning model using the methods described herein.

FIG. 5B shows clustering of missense genetic sequence variants along two principal components (using principal component analysis (PCA)) of certain features (verPhyloP, verPhastCons, GerpS, SIFT, PolyPhen) using the methods described herein. Simulated missense genetic sequence variants comprising an unlabeled mixture of benign missense genetic sequence variants and pathogenic missense genetic sequence variants are plotted using contour lines (labeled as “Simulated” and displayed as grey lines”) to demonstrate kernel density. A random subset of missense genetic sequence variants from both the benign missense genetic sequence variant testing data set (labeled “Benign” and displayed as closed circles) and the pathogenic missense genetic sequence variant testing data set (labeled “Pathogenic” and displayed as open circles) is shown.

FIG. 5C shows clustering of noncanonical splice genetic sequence variants along two principal components (using principal component analysis (PCA)) of certain features (verPhyloP, verPHastCons, HSF, GerpS, MaxEntScan, NNSplice) using the methods described herein. Simulated noncanonical splice genetic sequence variants comprising an unlabeled mixture of benign noncanonical splice genetic sequence variants and pathogenic noncanonical splice genetic sequence variants are plotted using contour lines (labeled as “Simulated” and displayed as grey lines”) to demonstrate kernel density. A random subset of noncanonical splice genetic sequence variants from both the benign noncanonical splice genetic sequence variant testing data set (labeled as “Benign” and displayed as blue dots) and the pathogenic noncanonical splice genetic sequence variant testing data set (labeled as “Pathogenic” and displayed as red dots) is shown. It is understood that FIG. 5C can be identically presented using alternative symbols (e.g., squares, crosses, circles, etc.) in place of the blue dots or red dots in a black and white drawing.

FIG. 5D shows clustering of noncoding (intergenic, regulatory, or intronic) region genetic sequence variants along two principal components (using principal component analysis (PCA)) of certain features (verPhyloP, verPhastCons, GerpS, ENCODE H3K27Ac, ENCODE H3K4Me3, ENCODE H3K4Me1) using the methods described herein. Simulated noncoding region genetic sequence variants comprising an unlabeled mixture of benign noncoding region genetic sequence variants and pathogenic noncoding region genetic sequence variants are plotted using contour lines to demonstrate kernel density. A random subset of noncoding (intergenic, regulatory, or intronic) region genetic sequence variants from both the benign noncoding region genetic sequence variant testing data set (blue dots) and the pathogenic noncoding region genetic sequence variant testing data set (red dots) is shown. It is understood that FIG. 5D can be identically presented using alternative symbols (e.g., squares, crosses, circles, etc.) in place of the blue dots or red dots in a black and white drawing.

FIGS. 6A and 6B show receiver operator characteristics (ROC) for pathogenic missense genetic sequence variants and benign missense genetic sequence variants calculated using one exemplary method (“SSCM-Pathogenic”) compared to other methods. Area-under-the curve (AUC) values are given along with 95% confidence intervals for the AUCs generated by dataset bootstrap sampling. FIG. 6A illustrates pathogenic missense genetic sequence variants from HGMD (n=63,363) and benign missense genetic sequence variants filtered by derived allele frequency of ≧0.05 and <0.95 (n=20,133). FIG. 6B illustrates pathogenic missense genetic sequence variants from ClinVar (n=18,783) and benign missense genetic sequence variants filtered by derived allele frequency of ≧0.05 and <0.95 (n=20,133).

FIGS. 7A and 7B show receiver operator characteristics (ROC) for pathogenic noncanonical splice genetic sequence variants and benign noncanonical splice genetic sequence variants calculated using one exemplary method (“SSCM-Pathogenic”) compared to other methods. Area-under-the curve (AUC) values are given along with 95% confidence intervals for the AUCs generated by dataset bootstrap sampling. FIG. 7A illustrates pathogenic noncanonical splice genetic sequence variants from HGMD (n=2,658) and benign noncanonical splice genetic sequence variants filtered by derived allele frequency of ≧0.05 and <0.95 (n=6,154). FIG. 7B illustrates pathogenic noncanonical splice genetic sequence variants from ClinVar (n=290) and benign noncanonical splice genetic sequence variants filtered by derived allele frequency of ≧0.05 and <0.95 (n=6,158).

FIG. 8 shows receiver operator characteristics (ROC) for pathogenic noncanonical splice genetic sequence variants and benign noncanonical splice genetic sequence variants calculated using one exemplary method (“SSCM-Pathogenic”) compared to an alternative exemplary method with splice features removed (“SSCM-Pathogenic (no splice features)”). Pathogenic noncanonical splice genetic sequence variants were obtained from HGMD (n=2,658) and benign noncanonical splice genetic sequence variants filtered by derived allele frequency of ≧0.05 and <0.95 (n=6,154). Area-under-the curve (AUC) values are given along with 95% confidence intervals for the AUCs generated by dataset bootstrap sampling.

FIG. 9 shows the pathogenic probability distribution outputted by an exemplary method described herein (“SSCM-Pathogenic”) for 3′-UTR genetic sequence variants, 5′-UTR genetic sequence variants, intronic region genetic sequence variants, and intergenic region genetic sequence variants. Note that all values are within [0,1] even though the density curve extends slightly outside of these bounds.

FIG. 10 shows receiver operator characteristics (ROC) for pathogenic missense genetic sequence variants and benign missense genetic sequence variants calculated using one exemplary method (“SSCM-Pathogenic”) compared to a supervised machine learning model. Pathogenic mis sense genetic sequence variants were obtained from HGMD (n=63,363) and benign missense genetic sequence variants filtered by derived allele frequency of ≧0.05 and <0.95 (n=20, 133). Area-under-the curve (AUC) values are given along with 95% confidence intervals for the AUCs generated by dataset bootstrap sampling.

### DETAILED DESCRIPTION

The present disclosure provides methods of predicting pathogenicity of a test genetic sequence variant. In some embodiments described herein, the method is a computer-implemented method of predicting pathogenicity of a test genetic sequence variant. The present disclosure further provides methods of training a machine learning model based on training data, the training data comprising a first data set comprising labeled benign genetic sequence variants and a second data set comprising unlabeled genetic sequence variants, the unlabeled genetic sequence variants comprising a mixture of benign genetic sequence variants and pathogenic genetic sequence variants. The present disclosure also provides methods of training a machine learning model based on training data, the training data comprising a first data set comprising labeled benign genetic sequence variants and a second data set comprising simulated genetic sequence variants, the simulated genetic sequence variants comprising an unlabeled mixture of benign genetic sequence variants and pathogenic genetic sequence variants. Also provided is a non-transitory computer-readable storage medium comprising computer-executable instructions for carrying out any of the methods described herein. Further provided is a computer system comprising one or more processors, memory, and one or more programs, wherein the one or more programs are stored in the memory and configured to be executed by the one or more processors, the one or more programs including instructions for carrying out any of the methods described herein.

Recent developments in cost-effective DNA sequencing allows for individualized genomic screening of a subject for genetic sequence variants. Once a genetic sequence variant from an individual is determined, it is helpful to a clinician to know how likely that genetic sequence variant is to be pathogenic. However, individual genetic sequence variants do not provide sufficient information to determine that likelihood of pathogenicity for that genetic sequence variant. Direct comparison to other known genetic sequence variants is generally unhelpful, for example, when the subject's genetic sequence variant is unique. Such unique genetic sequence variants have generally been classified as variants of uncertain significance instead of determining a likelihood of pathogenicity, thereby underutilizing the genetic sequence variant data. The systems and methods provided herein provide for predicting the pathogenicity of the subject's genetic sequence variants by utilized a trained machine learning model.

A significant challenge in training prior pathogenicity prediction models is ascertainment bias. Fully supervised modeling systems rely on a labeled (or “known”) benign genetic sequence variant training data set and a labeled pathogenic genetic sequence variant training data set. However, due to their pathogenicity, known pathogenic genetic sequence variants are typically low frequency difficult to acquire. Further, the known pathogenic genetic sequence variants are the more easily identified variants and are improperly enriched in databases relative to the entire population of pathogenic genetic sequence variants. This is particularly problematic for ensemble-type models (which pool and weight annotations from a plurality of sub-models), which require larger data sets to train.

It has been found, and is described herein, that training a pathogenicity prediction model using semi-supervised training methods produces a better model for predicting the pathogenicity of a test genetic sequence variant. The semi-supervised training method relies on a labeled benign genetic sequence variant training data set and an unlabeled genetic sequence variant training data set. Further, the model treats the unlabeled genetic sequence variant training data set as a mixture of benign genetic sequence variants and pathogenic genetic sequence variants. This training method provides a sufficiently large training data set to train a machine learning model useful for predicting pathogenicity, as the unlabeled genetic sequence variants do not require clinical studies to determine pathogenicity. Further, this method properly treats the unlabeled genetic sequence variants as a mixture of benign and pathogenic genetic sequence variants without assuming each component of the data set is inherently distinguishable from the labeled benign genetic sequence variant data set.

The methods for predicting pathogenicity described herein can be used for a broad range of genetic sequence variant types. In some embodiments the machine learning model is training using a genetic sequence variant data set comprising a broad range of genetic sequence variant types and is useful for predicting pathogenicity in a test genetic sequence variant with any genetic sequence variant. In some embodiments, the methods are more specialized for a particular genetic sequence variant type or a limited range of genetic sequence variant types. In such a specialized method, the machine learning model is trained using a genetic sequence variant training set comprising a limited number of genetic sequence variant types and is useful to predict the pathogenicity of a test genetic sequence variant comprising one of such genetic sequence variant types.

In the following descriptions of the disclosure and examples, reference is made to the accompanying drawings which illustrate specific examples that can be practiced. It is to be understood that other examples can be practiced and structural changes can be made without departing from the scope of the disclosure.

The machine learning model is trained using training data in a semi-supervised process. The training data comprises a first data set comprising labeled benign genetic sequence variants and a second data set comprising unlabeled genetic sequence variants, the unlabeled genetic sequence variants comprising a mixture of benign genetic sequence variants and pathogenic genetic sequence variants. In some embodiments, the unlabeled genetic sequence variants are simulated. In some embodiments, the method comprises training a machine learning model based on training data as described herein, annotating the genetic sequence variant with one or more features, and predicting a probability that the test genetic sequence variant is pathogenic based on the machine learning model after training. In some embodiments, the method is a computer-implemented method. In some embodiments, the computer-implemented method is performed at an electronic device having at least one processor and memory.

The genetic sequence variants in the training data are annotated with one or more features as described herein. The features assign a score to each genetic sequence variant, which is then used to train the machine learning model. The same features are then used to annotate the test genetic sequence variant so that the pathogenicity of the test genetic sequence variant can be predicted by the trained machine learning model. In some embodiments, the method comprises annotating a test genetic sequence variant with one or more features and predicting a probability that the test genetic sequence variant is pathogenic based on a trained machine learning model, wherein the machine learning model is trained based on training data as described herein. In some embodiments, the machine learning model is trained in a semi-supervised process. In some embodiments, the method is a computer-implemented method. In some embodiments, the computer-implemented method is performed at an electronic device having at least one processor and memory.

In some of the embodiments described herein, the method comprises receiving training data comprising a first data set comprising labeled benign genetic sequence variants and a second data set comprising unlabeled genetic sequence variants, the unlabeled genetic sequence variants comprising a mixture of benign genetic sequence variants and pathogenic genetic sequence variants; annotating each genetic sequence variant in the first data set and the second data set with one or more features; training a machine learning model based on the training data; annotating the test genetic sequence variant with the one or more features; and predicting a probability that the test genetic sequence variant is pathogenic based on the machine learning model after training. In some embodiments, the method further comprises receiving the test genetic sequence variant. In some embodiments, the machine learning model is trained in a semi-supervised process. In some embodiments, the method is a computer-implemented method. In some embodiments, the computer-implemented method is performed at an electronic device having at least one processor and memory.

In some of the embodiments described herein, the method comprises training a machine learning model based on training data as described herein, annotating a test genetic sequence variant with the one or more features, and predicting a probability that the test genetic sequence variant is pathogenic based on the machine learning model after training. In some embodiments, the machine learning model is trained in a semi-supervised process. In some embodiments, the method is a computer-implemented method. In some embodiments, the computer-implemented method is performed at an electronic device having at least one processor and memory.

In some embodiments of the methods described herein, the method further comprises generating the training data.

In some of the embodiments described herein, the training data comprises a first data set comprising labeled benign genetic sequence variants and a second data set comprising unlabeled genetic sequence variants. In some embodiments, the unlabeled genetic sequence variants comprise a mixture of benign genetic sequence variants and pathogenic genetic sequence variants. In some embodiments, the unlabeled genetic sequence variants are simulated genetic sequence variants. In some embodiments, the simulated genetic sequence variants are randomly simulated genetic sequence variants. In some embodiments, the labeled benign genetic sequence variants have an allele frequency greater than 90% in a selected population. In some embodiments, the genetic sequence variants in the first data set and the second data are annotated with the one or more features. In some embodiments, the test genetic sequence variant comprises a missense genetic sequence variant, a nonsense genetic sequence variant, a splice-site genetic sequence variant, an insertion genetic sequence variant, a deletion genetic sequence variant, or a regulatory element genetic sequence variant.

In some embodiments, the machine learning model assigns the test genetic sequence variant to a benign cluster or a pathogenic cluster. In some embodiments, the benign cluster comprises a plurality of benign sub-clusters. In some embodiments, the pathogenic cluster comprises a plurality of pathogenic sub-clusters. In some embodiments, the test genetic sequence variant is a human genetic sequence variant.

In some embodiments, the machine learning model comprises a generative model. In some embodiments, the generative model is a generative mixture model. In some embodiments, the generative model relies on one or more probability distribution specified by the one or more features. In some embodiments the one or more features comprise conditionally independent probability distributions. In some embodiments the one or more probability distributions comprise a plurality of nodes, the nodes comprising discrete features or continuous features, wherein the discrete features comprise a Dirichlet conditionally independent probability distribution and the continuous features comprise a Gaussian conditionally independent probability distribution. In some embodiments, the machine learning model comprises a discriminative model. In some embodiments, the machine learning model does not comprise a support vector machine.

In some embodiments, the semi-supervised process is performed by expectation-maximization. In some embodiments, the training comprises assigning each genetic sequence variant in the training data to a benign cluster or a pathogenic cluster. In some embodiments, the training comprises fixing one or more learning parameters for the benign clusters after n number of rounds of training; and allowing one or more learning parameters for the pathogenic clusters to vary for (n+x) rounds of training; wherein n and x are positive integers. In some embodiments, the one or more learning parameters for the benign clusters are fixed after one round of training. In some embodiments, the benign cluster comprises a plurality of benign sub-clusters. In some embodiments, the pathogenic cluster comprises a plurality of pathogenic sub-clusters.

In some embodiments, the features comprise a feature defined on a synonymous genetic sequence variant, missense genetic sequence variant, nonsense genetic sequence variant, a frame-shifting genetic sequence (such as an insertion genetic sequence variant or a deletion genetic sequence variant), a splice-site genetic sequence variant (such as a canonical splice-site genetic sequence variant or a non-canonical splice-site genetic sequence variant), a genetic sequence variant in a coding region, a genetic sequence variant in an intronic region, a genetic sequence variant in a promoter region, a genetic sequence variant in an enhancer region, a genetic sequence variant in a 3′-untranslated region (3′-UTR), a genetic sequence variant in a 5′-untranslated region (5′-UTR), a genetic sequence variant in an intergenic region, evolutionary conservation, regulatory element analysis, or functional genomic analysis.

### Method Architecture

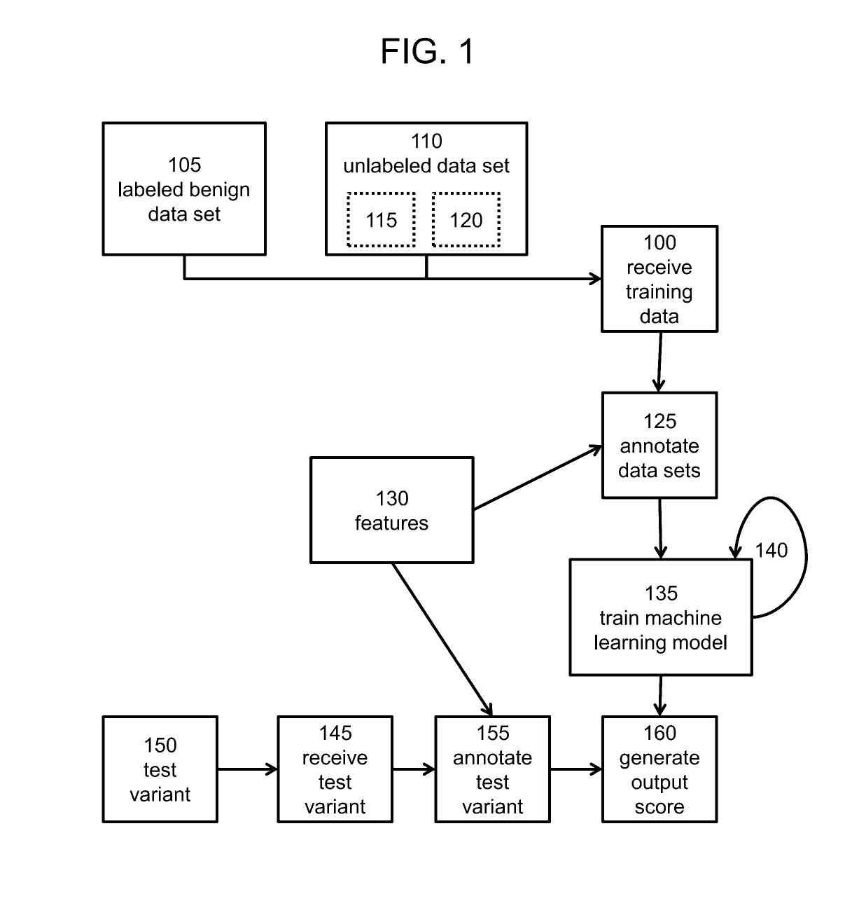

FIG. 1 illustrates one embodiment of the present invention, including an exemplary method that may be carried out by an electronic device having at least one processor and memory having instructions stored therein for carrying out the process. At step 100, the method includes receiving training data for use in training a machine learning model. The training data comprises a first data set 105 and a second data set 110. The first data set 105 comprises labeled benign genetic sequence variants. The second data set 110 comprises unlabeled genetic sequence variants, the unlabeled genetic sequence variants comprising a mixture of benign genetic sequence variants 115 and pathogenic genetic sequence variants 120. At step 125, the process annotates the first data set 105 and the second data set 110 with one or more features 130. At 135, a machine learning model is trained based on the training data (e.g., data set 105 and data set 110), wherein the machine learning model is trained in a semi-supervised process. In some embodiments, the training step 135 is performed iteratively, as indicated by the arrow at 140. At step 145, the electronic device receives one or more test genetic sequence variants 150. The one or more test genetic sequence variants 150 are then annotated at step 155 by the one or more features 130. At step 160, an output score is generated based on the machine learning model 135 after training. In some embodiments, the output score relates to the probability that the test genetic sequence variant is pathogenic.

### Computing Systems

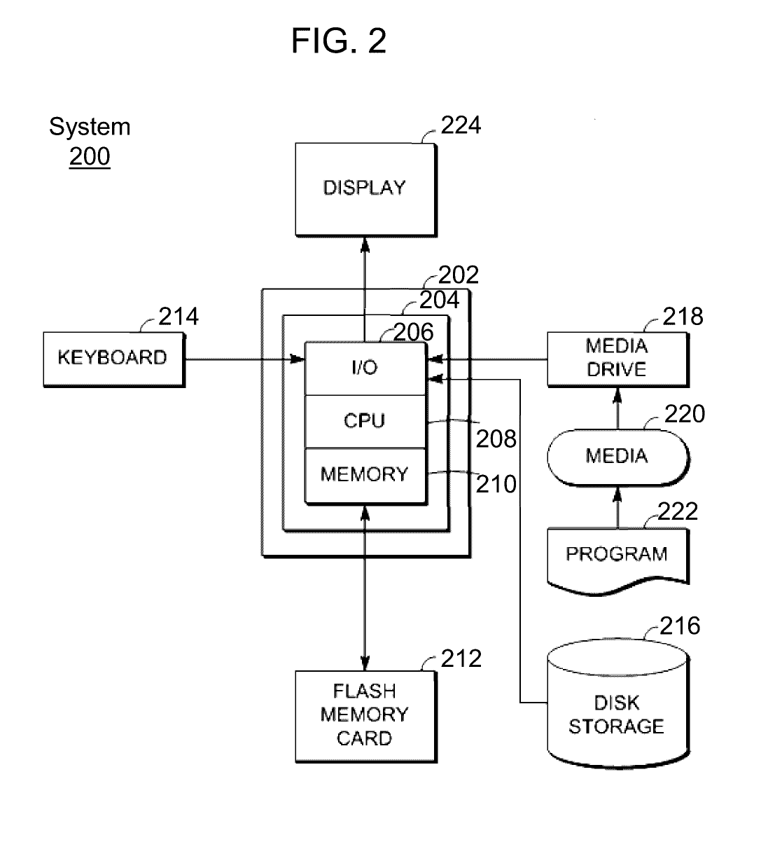

FIG. 2 depicts an exemplary computing system configured to perform any one of the processes described herein, including the various exemplary processes for predicting pathogenicity of a test genetic sequence variant. In this context, the computing system may include, for example, a processor, memory, storage, and input/output devices (e.g., monitor, keyboard, disk drive, Internet connection, etc.). However, the computing system may include circuitry or other specialized hardware for carrying out some or all aspects of the processes. In some operational settings, the computing system may be configured as a system that includes one or more units, each of which is configured to carry out some aspects of the processes either in software, hardware, or some combination thereof.

FIG. 2 depicts computing system 200 with a number of components that may be used to perform the processes described herein. The main system 202 includes a motherboard 204 having an input/output (“I/O”) section 206, one or more central processing units (“CPU”) 208, and a memory section 210, which may have a flash memory card 212 related to it. The I/O section 206 is connected to a display 224, a keyboard 214, a disk storage unit 216, and a media drive unit 218. The media drive unit 218 can read/write a computer-readable medium 220, which can contain programs 222 and/or data.

At least some values based on the results of the processes described herein can be saved for subsequent use. Additionally, a non-transitory computer-readable medium can be used to store (e.g., tangibly embody) one or more computer programs for performing any one of the above-described processes by means of a computer. The computer program may be written, for example, in a general-purpose programming language (e.g., Pascal, C, C++, Java, Python, JSON, etc.) or some specialized application-specific language.

### Training Data

The training data is used in the methods described herein to train the machine learning model. Exemplary systems and methods train a semi-supervised generative model using a genetic sequence variant training data set. The genetic sequence variant training data set comprises a labeled benign genetic sequence variant data set and an unlabeled genetic sequence variant data set. The labeled benign genetic sequence variant data comprise genetic sequence variants that are known to be benign. The unlabeled genetic sequence variant data set comprises genetic sequence variants with unknown pathogenicity. The genetic sequence variants are annotated using the features described herein and are used to train the machine learning model. The machine learning model uses the features to assign each genetic sequence variant in the unlabeled genetic sequence variant data set to pathogenic cluster or a benign cluster, and the machine learning model is trained by iteratively calculating model parameters.

In some embodiments, the labeled benign genetic sequence variant data set comprises high derived allele frequency genetic sequence variants. High derived allele frequency genetic sequence variants are assumed to be benign due to their evolutionary conservation. In some embodiments, the high allele frequency genetic sequence variants have a derived allele frequency of 0.9 or higher (such as 0.92 or higher, 0.95 or higher, 0.97 or higher, or 0.99 or higher). In some embodiments, the derived allele frequency is determined from a random population or a targeted population. Examples of targeted populations include a male population or a female population, but other targeted populations are contemplated. In some embodiments, the population is a human population. In some embodiments, the labeled benign genetic sequence variant data set comprises 100,000 or more genetic sequence variants (such as 200,000 or more genetic sequence variants, 300,000 or more genetic sequence variants, 500,000 or more genetic sequence variants, 750,000 or more genetic sequence variants, 1,000,000 or more genetic sequence variants, 1,250,000 or more genetic sequence variants, 1,500,000 or more genetic sequence variants, or 2,000,000 or more genetic sequence variants). The labeled benign genetic sequence variant data set can be obtained, for example, by filtering variants from the 1000 Genomes Project (1000G) (described in Abecasis et al., Nature, 491(7422):56-65 (2012)).

In some embodiments, the unlabeled genetic sequence variant data set comprises simulated genetic sequence variants wherein a locus was mutated in silico (e.g., by one or more processors running computer-readable instructions as described herein). The simulated genetic sequence variants can be generated, for example, by mutating a base in the genetic sequence according to a local mutation rate in a sliding window, for example a 1.1 Mb window. Local mutation rates can be determined, for example, by comparing the species genome to an inferred evolutionary ancestor, for example a human genome can be compared to an inferred human-chimpanzee ancestor. The bases in the genetic sequence can then be changed according to a genome-wide determined substitution matrix. One exemplary method for generating the simulated genetic sequence variants is the CADD variant simulation software (described in Kircher et al., Nature Genetics, 46(3):310-5 (2014), the disclosure of which is hereby incorporated by reference). In some of the embodiments of the methods described herein, the unlabeled simulated genetic sequence variant data set comprises a mixture of benign genetic sequence variants and pathogenic genetic sequence variants.

In some embodiments, the genetic sequence variant training data set comprises genetic sequence variants from a broad range of genetic sequence variant types. For example, in some embodiments, the genetic sequence variant training data set comprises genetic sequence variants with a missense mutation, a nonsense mutation, a frame-shifting genetic sequence variant (such as an insertion genetic sequence variant or a deletion genetic sequence variant), a splice-site genetic sequence variant (such as a canonical splice-site genetic sequence variant or a non-canonical splice-site genetic sequence variant)), a coding region variant, an intronic region variant, a promoter region variant, an enhancer region variant, a 3′-untranslated region (3′-UTR) variant, a 5′-untranslated region (5′-UTR) variant, an intergenic region variant, a dominant genetic sequence variant, a recessive genetic sequence variant, or a loss-of-function (LoF) genetic sequence variant. In some embodiments, both the labeled benign genetic sequence data set and the unlabeled genetic sequence data set comprise a broad range of genetic sequence variant types.

The methods provided herein can be broad-purpose methods of predicting pathogenicity or specialized methods of predicting pathogenicity based on the genetic sequence variant training data set used to train the machine learning model. For example, in some embodiments, the machine learning model is trained using a genetic sequence variant training data set comprising a broad range of genetic sequence variant types. In some embodiments, the method is specialized to predict pathogenicity in a single genetic sequence variant type or a subset of genetic sequence variant types. For example, in some embodiments, the machine learning model is trained using a genetic sequence variant training data set comprising genetic sequence variants with a missense mutation. In some embodiments, a machine learning model trained using a genetic sequence variant training data set comprising genetic sequence variants with a missense mutation is used to predict the pathogenicity of a test genetic sequence variant comprising a missense mutation. In some embodiments, a machine learning model is trained on a subset of genetic sequence variant types, for example missense genetic sequence variants, nonsense genetic sequence variants, and frame shifting genetic sequence variants. The genetic sequence variant training data set useful for training a specialized machine learning model comprises a labeled benign genetic sequence variant data set and an unlabeled genetic sequence variant data set (which is optionally a simulated unlabeled genetic sequence variant data set) with the same subset of genetic sequence variant types.

In some embodiments, the machine learning model is trained using a genetic sequence variant training data set comprising genetic sequence variants with a missense mutation. In some embodiments, a machine learning model trained using a genetic sequence variant training data set comprising genetic sequence variants with a missense mutation is used to predict the pathogenicity of a test genetic sequence variant comprising a missense mutation. In some embodiments, the machine learning model is trained using a genetic sequence variant training data set consisting of genetic sequence variants with a missense mutation. In some embodiments, a machine learning model trained using a genetic sequence variant training data set consisting of genetic sequence variants with a missense mutation is used to predict the pathogenicity of a test genetic sequence variant comprising a missense mutation.

In some embodiments, the machine learning model is trained using a genetic sequence variant training data set comprising genetic sequence variants with a nonsense mutation. In some embodiments, a machine learning model trained using a genetic sequence variant training data set comprising genetic sequence variants with a nonsense mutation is used to predict the pathogenicity of a test genetic sequence variant comprising a nonsense mutation. In some embodiments, the machine learning model is trained using a genetic sequence variant training data set consisting of genetic sequence variants with a nonsense mutation. In some embodiments, a machine learning model trained using a genetic sequence variant training data set consisting of genetic sequence variants with a nonsense mutation is used to predict the pathogenicity of a test genetic sequence variant comprising a nonsense mutation.

In some embodiments, the machine learning model is trained using a genetic sequence variant training data set comprising genetic sequence variants with a frame-shifting mutation. In some embodiments, a machine learning model trained using a genetic sequence variant training data set comprising genetic sequence variants with a frame-shifting mutation is used to predict the pathogenicity of a test genetic sequence variant comprising a frame-shifting mutation. In some embodiments, the machine learning model is trained using a genetic sequence variant training data set consisting of genetic sequence variants with a frame-shifting mutation. In some embodiments, a machine learning model trained using a genetic sequence variant training data set consisting of genetic sequence variants with a frame-shifting mutation is used to predict the pathogenicity of a test genetic sequence variant comprising a frame-shifting mutation.

In some embodiments, the machine learning model is trained using a genetic sequence variant training data set comprising genetic sequence variants with a splice-site mutation. In some embodiments, a machine learning model trained using a genetic sequence variant training data set comprising genetic sequence variants with a splice-site mutation is used to predict the pathogenicity of a test genetic sequence variant comprising a splice-site mutation. In some embodiments, the machine learning model is trained using a genetic sequence variant training data set consisting of genetic sequence variants with a splice-site mutation. In some embodiments, a machine learning model trained using a genetic sequence variant training data set consisting of genetic sequence variants with a splice-site mutation is used to predict the pathogenicity of a test genetic sequence variant comprising a splice-site mutation.

In some embodiments, the machine learning model is trained using a genetic sequence variant training data set comprising genetic sequence variants with a mutation in a coding region. In some embodiments, a machine learning model trained using a genetic sequence variant training data set comprising genetic sequence variants with a mutation in a coding region is used to predict the pathogenicity of a test genetic sequence variant comprising a mutation in a coding region. In some embodiments, the machine learning model is trained using a genetic sequence variant training data set consisting of genetic sequence variants with a mutation in a coding region. In some embodiments, a machine learning model trained using a genetic sequence variant training data set consisting of genetic sequence variants with a mutation in a coding region is used to predict the pathogenicity of a test genetic sequence variant comprising a mutation in a coding region.

In some embodiments, the machine learning model is trained using a genetic sequence variant training data set comprising genetic sequence variants with a mutation in an intronic region. In some embodiments, a machine learning model trained using a genetic sequence variant training data set comprising genetic sequence variants with a mutation in an intronic region is used to predict the pathogenicity of a test genetic sequence variant comprising a mutation in an intronic region. In some embodiments, the machine learning model is trained using a genetic sequence variant training data set consisting of genetic sequence variants with a mutation in an intronic region. In some embodiments, a machine learning model trained using a genetic sequence variant training data set consisting of genetic sequence variants with a mutation in an intronic region is used to predict the pathogenicity of a test genetic sequence variant comprising a mutation in an intronic region.

In some embodiments, the machine learning model is trained using a genetic sequence variant training data set comprising genetic sequence variants with a mutation in a promoter region. In some embodiments, a machine learning model trained using a genetic sequence variant training data set comprising genetic sequence variants with a mutation in a promoter region is used to predict the pathogenicity of a test genetic sequence variant comprising a mutation in an promoter region. In some embodiments, the machine learning model is trained using a genetic sequence variant training data set consisting of genetic sequence variants with a mutation in a promoter region. In some embodiments, a machine learning model trained using a genetic sequence variant training data set consisting of genetic sequence variants with a mutation in a promoter region is used to predict the pathogenicity of a test genetic sequence variant comprising a mutation in a promoter region.

In some embodiments, the machine learning model is trained using a genetic sequence variant training data set comprising genetic sequence variants with a mutation in an enhancer region. In some embodiments, a machine learning model trained using a genetic sequence variant training data set comprising genetic sequence variants with a mutation in an enhancer region is used to predict the pathogenicity of a test genetic sequence variant comprising a mutation in an enhancer region. In some embodiments, the machine learning model is trained using a genetic sequence variant training data set consisting of genetic sequence variants with a mutation in an enhancer region. In some embodiments, a machine learning model trained using a genetic sequence variant training data set consisting of genetic sequence variants with a mutation in an enhancer region is used to predict the pathogenicity of a test genetic sequence variant comprising a mutation in an enhancer region.

In some embodiments, the machine learning model is trained using a genetic sequence variant training data set comprising genetic sequence variants with a mutation in a 3′-untranslated region (3′-UTR). In some embodiments, a machine learning model trained using a genetic sequence variant training data set comprising genetic sequence variants with a mutation in a 3′-untranslated region (3′-UTR) is used to predict the pathogenicity of a test genetic sequence variant comprising a mutation in a 3′-untranslated region (3′-UTR). In some embodiments, the machine learning model is trained using a genetic sequence variant training data set consisting of genetic sequence variants with a mutation in a 3′-untranslated region (3′-UTR). In some embodiments, a machine learning model trained using a genetic sequence variant training data set consisting of genetic sequence variants with a mutation in a 3′-untranslated region (3′-UTR) is used to predict the pathogenicity of a test genetic sequence variant comprising a mutation in a 3′-untranslated region (3′-UTR).

In some embodiments, the machine learning model is trained using a genetic sequence variant training data set comprising genetic sequence variants with a mutation in a 5′-untranslated region (5′-UTR). In some embodiments, a machine learning model trained using a genetic sequence variant training data set comprising genetic sequence variants with a mutation in a 5′-untranslated region (5′-UTR) is used to predict the pathogenicity of a test genetic sequence variant comprising a mutation in a 5′-untranslated region (5′-UTR). In some embodiments, the machine learning model is trained using a genetic sequence variant training data set consisting of genetic sequence variants with a mutation in a 5′-untranslated region (5′-UTR). In some embodiments, a machine learning model trained using a genetic sequence variant training data set consisting of genetic sequence variants with a mutation in a 5′-untranslated region (5′-UTR) is used to predict the pathogenicity of a test genetic sequence variant comprising a mutation in a 5′-untranslated region (5′-UTR).

In some embodiments, the machine learning model is trained using a genetic sequence variant training data set comprising genetic sequence variants with a mutation in an intergenic region. In some embodiments, a machine learning model trained using a genetic sequence variant training data set comprising genetic sequence variants with a mutation in an intergenic region is used to predict the pathogenicity of a test genetic sequence variant comprising a mutation in an intergenic region. In some embodiments, the machine learning model is trained using a genetic sequence variant training data set consisting of genetic sequence variants with a mutation in an intergenic region. In some embodiments, a machine learning model trained using a genetic sequence variant training data set consisting of genetic sequence variants with a mutation in an intergenic region is used to predict the pathogenicity of a test genetic sequence variant comprising a mutation in an intergenic region.

In some embodiments, the machine learning model is trained using a genetic sequence variant training data set comprising genetic sequence variants with a mutation in a dominant gene. In some embodiments, a machine learning model trained using a genetic sequence variant training data set comprising genetic sequence variants with a mutation in a dominant gene is used to predict the pathogenicity of a test genetic sequence variant comprising a mutation in an a dominant gene. In some embodiments, the machine learning model is trained using a genetic sequence variant training data set consisting of genetic sequence variants with a mutation in a dominant gene. In some embodiments, a machine learning model trained using a genetic sequence variant training data set consisting of genetic sequence variants with a mutation in a dominant gene is used to predict the pathogenicity of a test genetic sequence variant comprising a mutation in a dominant gene.

In some embodiments, the machine learning model is trained using a genetic sequence variant training data set comprising genetic sequence variants with a mutation in a recessive gene. In some embodiments, a machine learning model trained using a genetic sequence variant training data set comprising genetic sequence variants with a mutation in a recessive gene is used to predict the pathogenicity of a test genetic sequence variant comprising a mutation in an a recessive gene. In some embodiments, the machine learning model is trained using a genetic sequence variant training data set consisting of genetic sequence variants with a mutation in a recessive gene. In some embodiments, a machine learning model trained using a genetic sequence variant training data set consisting of genetic sequence variants with a mutation in a recessive gene is used to predict the pathogenicity of a test genetic sequence variant comprising a mutation in a recessive gene.

In some embodiments, the machine learning model is trained using a genetic sequence variant training data set comprising genetic sequence variants with a loss-of function mutation. In some embodiments, a machine learning model trained using a genetic sequence variant training data set comprising genetic sequence variants with a loss-of function mutation is used to predict the pathogenicity of a test genetic sequence variant comprising a loss-of function mutation. In some embodiments, the machine learning model is trained using a genetic sequence variant training data set consisting of genetic sequence variants with a loss-of function mutation. In some embodiments, a machine learning model trained using a genetic sequence variant training data set consisting of genetic sequence variants with a loss-of function mutation is used to predict the pathogenicity of a test genetic sequence variant comprising a loss-of function mutation.

In some embodiments, each genetic sequence variant in the genetic sequence variant training data set (including the known benign genetic sequence variant data set and the simulated genetic sequence variant data set) is annotated by one or more features using the methods disclosed herein.

### Feature Annotation of Genetic Sequence Variants

In some embodiments of the methods disclosed herein, exemplary systems and methods annotate a training genetic sequence variant with one or more features. The features are used to characterize properties of the genetic sequence variants, and can include, for example, scores defined on sequence conservation, missense genetic sequence variants, splice-site genetic sequence variants, or regulatory elements. In some embodiments, the genetic sequence variants in the labeled benign genetic sequence variant data set or the genetic sequence variants in the unlabeled genetic sequence variant data set are annotated with one or more features. In some embodiments, a test genetic sequence variant is annotated with the one or more features.

In some embodiments, one or more of the features are categorical features, such as the genetic consequence of the genetic sequence variant (such as a synonymous genetic sequence variant, missense genetic sequence variant, nonsense genetic sequence variant, a frame-shifting genetic sequence variant (such as an insertion genetic sequence variant or a deletion genetic sequence variant), or a splice-site genetic sequence variant (such as a canonical splice-site genetic sequence variant or a non-canonical splice-site genetic sequence variant)) or genomic region of the genetic sequence variant (such as a genetic sequence variant in a coding region, such as a genetic sequence variant in an intronic region, a genetic sequence variant in a promoter region, a genetic sequence variant in an enhancer region, a genetic sequence variant in a 3′-untranslated region (3′-UTR), a genetic sequence variant in a 5′-untranslated region (5′-UTR), or a genetic sequence variant in an intergenic region). In some embodiments, one or more of the features are numerical scores, such as probability of mutation impact on protein function (e.g., SIFT scores) or evolutionary conservation (e.g., PhyloP scores or PhastCons scores).

The features can be vector scores or scalar scores. For example, in some embodiments a vector score is a vector of multiple levels of evolutionary conservation, such as evolutionary conservation across all vertebrates, across all mammals, or across all primates. In some embodiments, a portion of the features are vector scores. In some embodiments, a portion of the features are scalar scores.

In some embodiments, the features are defined on a variant type (such as a synonymous genetic sequence variant, missense genetic sequence variant, nonsense genetic sequence variant, a frame-shifting genetic sequence (such as an insertion genetic sequence variant or a deletion genetic sequence variant), a splice-site genetic sequence variant (such as a canonical splice-site genetic sequence variant or a non-canonical splice-site genetic sequence variant), a genetic sequence variant in a coding region, such as a genetic sequence variant in an intronic region, a genetic sequence variant in a promoter region, a genetic sequence variant in an enhancer region, a genetic sequence variant in a 3′-untranslated region (3′-UTR), a genetic sequence variant in a 5′-untranslated region (5′-UTR), a genetic sequence variant in an intergenic region, evolutionary conservation, regulatory element analysis, or functional genomic analysis).

In some embodiments, a feature that is defined on missense variants is generated using sequence homology within coding regions to determine how disruptive a missense variant in the genetic sequence variant might be. Example methods useful for generating a feature defined on missense variants include SIFT (described in Ng & Henikoff, Nucleic Acids Research, 31(13): 3812-4 (2003) and Kumar et al., Nat. Protoc. 4(7):1073-81 (2009)) and PolyPhen2 (described in Adzhubei et al., Nature Methods, 7(4):248-9 (2010)). In some embodiments, a feature that is defined on a frame-shifting genetic sequence variant is generated using sequence homology within coding regions to determine how disruptive an a frame-shifting genetic sequence variant might be. Example methods useful for generating a feature defined on a frame-shifting genetic sequence variants include PROVEAN (described in Choi et al., PLoS ONE, 7(10) (2012)) and SIFT Indel (described in Hu & Ng, PLoS ONE, 8(10) (2013)). In some embodiments, the feature that is defined on missense genetic sequence variant or a frame-shifting genetic sequence variant is generated using a probabilistic model to score genetic sequence variant. Example methods useful for generating a feature defined on probabilistic scores include LRT (described in Chun & Fay, Genome Research, 19(9):1553-61 (2009)) and MAPP (described in Stone & Sidow, Genome Research, 15(7):978-86 (2005)). In some embodiments, a feature that is defined on nonsense variants is generated using sequence homology within coding regions to determine how disruptive a nonsense variant in the genetic sequence variant might be.

In some embodiments, a feature that is defined on a splice-site genetic sequence variant is generated using a predicted probability that a given genetic sequence variant will alter the splicing of a transcript. Aberrant splicing can create a large effect on a downstream protein with a very small nucleotide change, which may result in a pathogenic genetic sequence variant. Example methods useful for generating a feature defined on splice-site variants include MutPred Splice (described in Mort et al., Genome Biology, 15(1):R19 (2014)), Human Splicing Finder (HSF) (described in Desmet et al., Nucleic Acids Research, 37(9):e67 (2009)), MaxEntScan (described in Yeo & Burge, Journal of Computational Biology, 11(2-3):337-394 (2004)), and NNSplice (described in Reese et al., Journal of Computational Biology, 4(3):311-323 (1997)).

In some embodiments, a feature that is defined on evolutionary conservation of a genetic sequence variant is generated by predicting whether a genetic sequence variant disrupts a site that has been conserved or has been under negative selection over a predicted evolutionary timespan. Example methods useful for generating a feature defined on evolutionary conservation include GERP (described in Davydov et al., PLoS Computational Biology, 6(12) (2010)), PhastCons (described in Siepel et al., Genome Research, 15(8):1034-1050 (2005)), PhyloP (described in Pollard et al., Genome Research, 20(1):110-21 (2010)), verPhyloP (similar to PhyloP, but relying on vertebrate sequences), and verPhastCons (similar to PhastCons, but relying on vertebrate sequences).

In some embodiments, a feature that is defined on a functional genomic analysis of the genetic sequence variant is generated by comparing the location and sequence of the genetic sequence variant to locations of annotated functional genomic regions. For example, in some embodiments, the functional annotation features evaluate the probability that a given genetic sequence variant will impact an enhancer or promoter region, or other regulatory element, in a genome. For example, the ENCODE (described in Bernstein et al., Nature, 489(7414): 57-74 (2012)) and Epigenome Roadmap (described in Kundaje et al., Nature, 518(7539):317-330 (2015)) projects, provide information about the relative functionality of different regions of the genome. Example methods useful for generating a feature defined on a functional genomic analysis of the genetic sequence variants include ChromHMM (described in Ernst & Kellis, Nature methods, 9(3):215-6 (2014)), SegWay (described in Hoffman et al., Nature Methods, 9(5):473-6 (2012)), and FitCons (Gulko et al., Nature Genetics, 47(3):276-283 (2015)).

The methods described herein allow for annotating genetic sequence variants with an ensemble of features. In some embodiments, genetic sequence variants are annotated with 1 or more (such as 2 or more, 3 or more, 4 or more, 5 or more, 6 or more, 7 or more, 8 or more, 9 or more, 10 or more, 12 or more, 15 or more, 20 or more, 25 or more, 30 or more, 40 or more, 50 or more, or 60 or more) features. The sequences can be annotated using, for example, Ensembl's Variant Effect Predictor, as described in McLaren et al., Bioinformatics, 26(16): 2069-70 (2010). In some embodiments, a portion of the genetic sequence variants are unable to be annotated with one or more features. In some embodiments, such missing data is integrated out of the generative model. Table 1 provides examples and descriptions of features that can be used in some embodiments of the disclosed methods.

TABLE 1
List of features used in some embodiments
of the methods described herein.
Annotating features in addition to the ones
listed are contemplated by the present invention.

| Feature Name | Description |
|---|---|
| verPhyloP | Vertebrate PhyloP (verPhyloP) generated an evolutionary |
| | conservation score by comparing alleles to those generated by a |
| | neutral phylogenetic evolution model for vertebrate species. |
| verPhastCons | Vertebrate PhastCons (verPhastCons) generates an evolution |
| | conservation score by an alignment with a phylogenetic hidden |
| | Markov model (HMM). |
| Gerp++ RS | Gerp++ RS generates an evolutionary conservation score by taking |
| | a multiple sequence alignment and finding constrained elements |
| | (regions where fewer substitutions occur. |
| SIFT | SIFT predicts the probability a genetic sequence variant will affect |
| | protein function by comparing the amino acid sequence to similar |
| | sequences in other proteins. |
| PolyPhen2 | PolyPhen2 predicts whether a mutation is damaging to protein |
| | structure by using features extracted from sequence alignment. |
| HSF | HSF predicts the effect of mutations in splice sites by comparing |
| | sequences to known motifs. |
| MaxEnt | MaxEnt uses maximum entropy modeling to discover 3′ and 5′ |
| | splicing sites. |
| NNSplice | NNSplice uses a neural network to predict splice site locations. |
| ENCODE H3K27Ac | ENCODE H3K27Ac predicts enhancer and promoter sites defined |
| | on predicted histone marker H3K27Ac locations. |
| ENCODE H3K4Me3 | ENCODE H3K4Me3 predicts enhancer and promoter sites defined |
| | on predicted histone marker H3K4Me3 locations. |
| ENCODE H3K4Me1 | ENCODE H3K4Me1 predicts enhancer and promoter sites defined |
| | on predicted histone marker H3K4Me1 locations. |

### Machine Learning Model for Genetic Sequence Variants

The genetic sequence variant training data set comprising the labeled benign genetic sequence variant data set and the unlabeled genetic sequence variant data set is annotated with one or more features described herein and is used to train a machine learning model in a semi-supervised process. In some embodiments, the machine learning model is a generative model, such as a generative mixture model. It is also contemplated, however, that the machine learning model is a discriminative model. In some embodiments, the machine learning model does not comprise a support vector machine. Each annotated genetic sequence variant in the genetic sequence variant training data set are assigned to either a benign cluster or a pathogenic cluster based on calculated model parameters. Generally, the model parameters are iteratively calculated using an expectation-maximization algorithm until convergence of the probability of correct cluster assignment of the genetic sequence variant training data set. The calculated parameters are then fixed and used by the trained machine learning model. The trained machine learning model is then used to predict the probability that a test genetic sequence variant is pathogenic by determining the probability of correct assignment to a pathogenic cluster or a benign cluster.

The machine learning model assumes each genetic sequence variant in the genetic sequence variant training data set fits into either a pathogenic cluster or a benign cluster, represented in the machine learning model by the hidden variable cluster assignment. In some embodiments, the machine learning model assumes each genetic sequence variant in the genetic sequence variant training data set fits into a plurality of pathogenic clusters (or “pathogenic sub-clusters”) or a plurality of benign clusters (or “benign sub-clusters”), represented in the machine learning model as the hidden variable cluster assignment. Each genetic sequence variant is also annotated with a plurality of independent features, as described herein. These features each have their own probability distribution conditionally independent from their cluster assignments. Further, the probability distribution of each feature is calculated according to parameters drawn from a parameter matrix. The parameters are iteratively updated based on the maximum likelihood that the feature annotation of each genetic sequence variant fits the cluster assignment of the genetic sequence variant. Cluster assignment for each genetic sequence variants is then calculated by generating a multinomial distribution based on the features and calculated parameters, and a probability of correct cluster assignment for the genetic sequence variant training data set is calculated. Initial parameters are determined by restricting the genetic sequence variants in the labeled benign genetic sequence variant data set to the benign cluster. In some embodiments, the parameters are iteratively determined, for example by using an expectation-maximization algorithm, until convergence of the probability of correct assignment of the genetic sequence variants to either the benign cluster or the pathogenic cluster. During this iterative calculation, genetic sequence variants in the labeled benign genetic sequence variant data set are restricted to the benign cluster and the genetic sequence variants in the unlabeled genetic sequence variant data set are allowed to be assigned to any cluster based on the generative model.

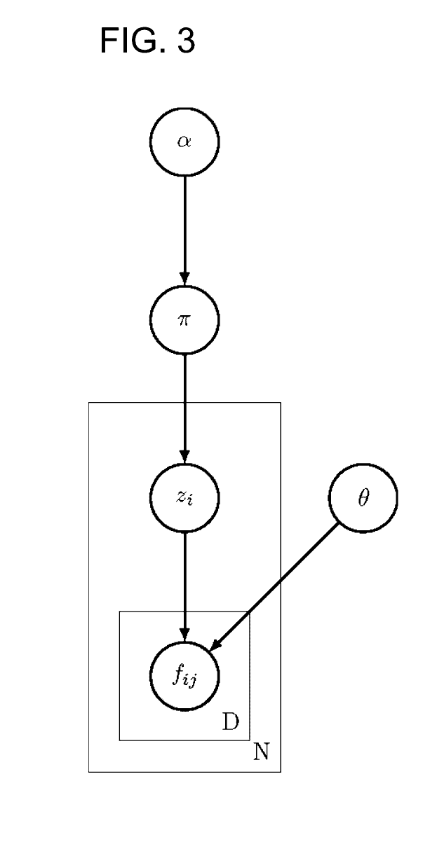

FIG. 3 illustrates one embodiments of a generative model useful for the process described herein. The generative model is further described by the equations provided herein. The genetic sequence variant training data set is represented as X={xᵢ}ᵢ₌₁^{N}, with xᵢ representing any given genetic sequence variant. Each genetic sequence variant has a cluster assignment represented by hidden variable, zᵢ. In some embodiments, the cluster assignment is a pathogenic cluster or a benign cluster. In some embodiments, the cluster assignment is to a sub-cluster in a plurality of pathogenic sub-clusters or a sub-cluster in a plurality of benign sub-clusters. Each genetic sequence variant in the genetic sequence variant training data set is annotated with D features such that xᵢ={fᵢⱼ}ⱼ₌₁^{D}. Each of the one or more features are conditionally independent given the cluster assignment, zᵢ, for any given genetic sequence variant. Further, each of the one or more features has a learning parameter for each cluster (either benign cluster or pathogenic cluster) or sub-cluster drawn from a learning parameter matrix, θ, such that each of the one or more features has a probability distribution, pⱼ(fᵢⱼ|θ_{z}_{ᵢ}ⱼ). A multinomial distribution for each cluster, zᵢ, is assumed with a parameter π with a Dirichlet prior on π and a hyperparameter, α.

$$π \vert α ∼ Dirichlet ( \frac{α}{K} , \frac{α}{K} , … , \frac{α}{K} )$$

$${z}_{i} \vert π {∼}^{i . i . d .} Multinomial ( 1 , π )$$

$${f}_{ij} \vert {z}_{i} , θ {∼}^{ind .} {p}_{j} ( {f}_{ij} \vert {θ}_{z , j} )$$

In some embodiments, a univariate Gaussian or multinomial distribution is assigned to each of the D features. In some embodiments, multiple features of a genetic sequence variant were grouped into vectors and assigned a multivariate Gaussian distribution to the compound feature vector. Grouping the multiple features into a compound feature vector with a multivariate Gaussian distribution helps mitigate the effect of the naive Bayes assumption.

In some embodiments, an expectation-maximization algorithm is used to iteratively determine parameters π and θ and calculate probabilities of correct cluster assignment, zᵢ, of the genetic sequence variants. The expectation-maximization algorithm relies on a first expectation step of calculating the probability that any given genetic sequence variant is properly assigned to cluster given a set of parameters and a second maximization step of updating the parameters to obtain higher probabilities of correct cluster assignments. The first step and the second step proceed iteratively until the probabilities of correct cluster assignment converge.

In some embodiments, the labeled benign genetic sequence variant data set is used to define initial estimates of the parameters π and θ for the benign cluster by fixing the cluster assignment, zᵢ, as the benign cluster for each genetic sequence variant in the labeled benign genetic sequence variant data set. In some embodiments, these initial estimates of the parameters π and θ set for the benign cluster were then used for initial parameters π and θ for the pathogenic cluster. Soft cluster assignments, zᵢ, were then made for the unlabeled synthetic genetic sequence variant data set to either the benign cluster or the pathogenic cluster. After the initial fitting of the generative model (i.e., after one round of training and determining the initial parameters π and θ for the benign cluster), the parameters π and θ for the benign cluster were fixed and the parameters π and θ for the pathogenic cluster were updated. In some embodiments, the learning parameters for the benign cluster were fixed after two or more rounds of training and the learning parameters for the pathogenic cluster were allowed to be updated. For example, in some embodiments, one or more learning parameters for the benign clusters is fixed after n number of rounds of training and the learning parameters for the pathogenic clusters were allowed to be updated for (n+x) rounds of training, wherein n and x are positive integers.

In some embodiments, during each round of training, the expectation-maximization algorithm iteratively calculates posterior probabilities of the hidden variable zᵢ for each genetic sequence variant and updates the values of the parameters π and θ for the pathogenic cluster to maximize the likelihood of the data given the soft cluster assignments, zᵢ.

The following is an exemplary expectation-maximization algorithm that may be useful for the processes described herein. Parameters π and θ for the pathogenic cluster were updated for each round of training, t, based on the univariate Gaussian feature probability distribution, multinomial feature probability distribution, and/or multivariate Gaussian feature probability distribution, which are also update for each round of training, t.

τᵢ^{k(t)}=p(zᵢ=k|xᵢ,π^{(t)},θ^{(t)})

Parameter π=[π₁, π₂, . . . , π_{K}] was updated for the pathogenic cluster for each round of training:

$${π}_{k}^{( t + 1 )} = \frac{\frac{α}{K} - 1 + {\sum }_{i = 1}^{N} {τ}_{i}^{k ( t )}}{N - K + α}$$

If the feature has a univariate Gaussian distribution, the feature is updated for cluster assignment zᵢ=a and feature j=b by:

$${μ}_{ab}^{( t + 1 )} = \frac{{\sum }_{i = 1}^{N} {τ}_{i}^{a ( t )} {f}_{ib}}{{\sum }_{i = 1}^{N} {τ}_{i}^{a ( t )}}$$

$${σ}_{ab}^{2 ( t + 1 )} = \frac{{\sum }_{i = 1}^{N} {{τ}_{i}^{a ( t )} ( {f}_{ib} - {μ}_{ab}^{( t + 1 )} )}^{2}}{{\sum }_{i = 1}^{N} {τ}_{i}^{a ( t )}}$$

If the feature has a multinomial distribution, for the cluster assignment zᵢ=a and feature j=b, the updates for each component vector of the learning parameter vector p_{ab}=[p_{ab0}, p_{ab1}, . . . , p_{abL}] are:

$${p}_{abv}^{( t + 1 )} = \frac{{\sum }_{i = 1}^{N} 𝕀 ( {f}_{ib} = v ) {τ}_{i}^{a ( t )}}{{\sum }_{i = 1}^{L} {\sum }_{i = 1}^{N} 𝕀 ( {f}_{ib} - l ) {τ}_{i}^{a ( t )}}$$

If the feature has a multivariate Gaussian, the feature is updated for cluster assignment zᵢ=a and feature j=b by:

$${μ}_{ab}^{( t + 1 )} = \frac{{\sum }_{i = 1}^{N} {τ}_{i}^{a ( t )} {f}_{ib}}{{\sum }_{i = 1}^{N} {τ}_{i}^{a ( t )}}$$

$${\sum }_{ab}^{( t + 1 )} = \frac{{\sum }_{i = 1}^{N} {τ}_{i}^{a ( t )} ( {f}_{ib} - {μ}_{ab}^{( t + 1 )} ) {( {f}_{ib} - {μ}_{ab}^{( t + 1 )} )}^{T}}{{\sum }_{i = 1}^{N} {τ}_{i}^{a ( t )}}$$

In some embodiments, a portion of the genetic sequence variant training data set is unable to be annotated with one or more features, resulting in missing features. This is largely due to features being defined only in certain regions of the genome. For example, some features are define only on missense variants, and not all genetic sequence variants comprise missense variants. Therefore, in some embodiments, to account for the missing features in a Bayesian manner, features that were not present in a particular genetic sequence variant were integrated out. The multivariate Gaussian learning parameters were also updated by calculating the mean vector and covariance matrix for each vector scores. However, in some circumstances, one or more missing features resulted in a non-positive semidefinite covariance matrix. In some embodiments, the non-positive semidefinite covariance matrix is corrected by computing the eigendecomposition of the matrix, setting the negative eigenvalues to a slightly positive number, and regenerating the matrix as a positive semidefinite covariance matrix.

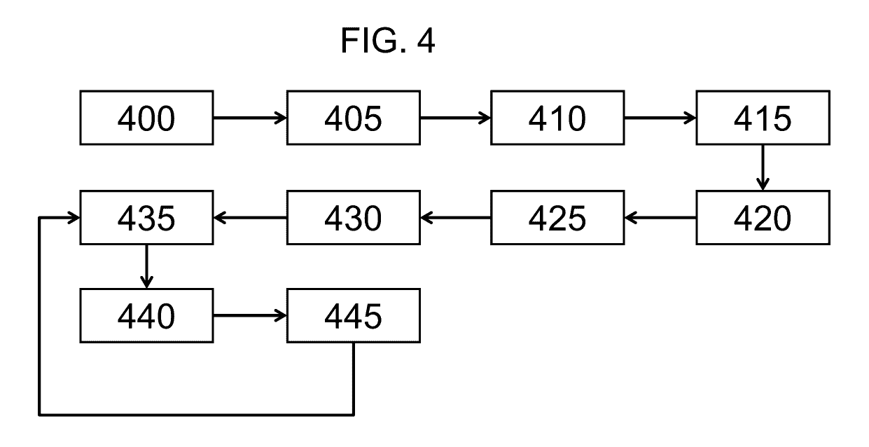

FIG. 4 illustrates one embodiment of a process using an expectation-maximization algorithm to train a generative machine learning model based on the genetic sequence variant data set as described herein. The genetic sequence variant data set comprises the labeled benign genetic sequence variant data set and the unlabeled genetic sequence variant data set. At step 400, each genetic sequence variant in the genetic sequence variant training data set is annotated with a plurality of features. At step 405, each feature in the plurality of features is assigned a feature probability distribution. In some embodiments, the probability distribution is a univariate Gaussian probability distribution or a multinomial probability distribution. Optionally, multiple features are grouped into vectors and the vector is assigned a multivariate Gaussian probability distribution. At step 410, each genetic sequence variant in the labeled genetic sequence variant data set is assigned to a benign cluster defined by a multinomial probability distribution. At step 415, each feature is assigned a first parameter for the benign cluster from a parameter matrix such that each feature probability distribution is related to the benign cluster assignment. At step 420, the multinomial probability distribution defining the benign cluster assignment is assigned a second parameter for the benign cluster with a Dirichlet prior and a hyperparameter. The first parameter assigned at step 415 and the second parameter assigned at step 420 are both calculated based on the maximum likelihood estimate of the parameters given the feature probability distributions and the known assignment to the benign cluster of each genetic sequence variant in the labeled genetic sequence variant data set. At step 425, the first parameter for the pathogenic cluster is set to the first parameter for the benign cluster. At step 430, the second parameter for the pathogenic cluster is set to the second parameter of the benign cluster. At step 435, each genetic sequence variant in the unlabeled synthetic genetic sequence variant data set is given a soft assignment to the benign cluster or the pathogenic cluster based on a multinomial distribution defining the benign cluster, which has the second parameter for the benign cluster, or a multinomial distribution defining the pathogenic cluster, which has a second parameter for the pathogenic cluster. Both the multinomial distribution defining the benign cluster and the multinomial distribution defining the pathogenic cluster include a Dirichlet prior on the multinomial distribution and a hyperparameter common to the multinomial distributions. At step 440, a posterior probability of correct assignment of the genetic sequence variants into the benign cluster or the pathogenic cluster is calculated. At step 445, the first parameter for the pathogenic cluster, the second parameter for the pathogenic cluster, and that feature probability distributions are updated to maximize the likelihood of the feature annotations of each genetic sequence variant in the genetic sequence variant training data set. The first parameter for the benign cluster and the second parameter for the benign cluster are not updated at step 445. Steps 435, 440, and 445 are iteratively repeated until convergence of the likelihood of the feature annotations of each genetic sequence variant in the genetic sequence variant training data set. It is understood that, in some embodiments, the described steps can be performed in alternative order. For example, it is understood that step 415 and step 420 can be performed simultaneously, step 415 can be performed prior to step 420, or step 420 can be performed prior to step 415.

### Testing Genetic Sequence Variants

Once the machine learning model was trained using the genetic sequence variant training data set, the parameters π and θ were fixed as determined by the last iteration. In some embodiments, the trained machine learning model as described herein is applied to a test genetic sequence variant to obtain an output score. The output score is a predicted probability that the test genetic sequence variant is pathogenic. In some embodiments, the trained learning model receives the test genetic sequence variant. In some embodiments, the trained learning model calculates a posterior probability for the assignment of the test genetic sequence variant to each of clusters (benign cluster or pathogenic cluster).

In some embodiments, the test genetic sequence variant is a test genetic sequence variant from any organism. In some embodiments, the test genetic sequence variant is a primate test genetic sequence variant, a rodent test genetic sequence variant, a fish genetic sequence variant, a fruit fly genetic sequence variant, a prokaryotic genetic sequence variant, a yeast genetic sequence variant, a nematode genetic sequence variant, or a plant genetic sequence variant.

### EXAMPLES

Various exemplary embodiments are described herein. Reference is made to these examples in a non-limiting sense. They are provided to illustrate more broadly applicable aspects of the disclosed technology. Various changes may be made and equivalents may be substituted without departing from the true spirit and scope of the various embodiments. In addition, many modifications may be made to adapt a particular situation, material, composition of matter, process, process act(s) or step(s) to the objective(s), spirit or scope of the various embodiments. Further, as will be appreciated by those with skill in the art, each of the individual variations described and illustrated herein has discrete components and features that may be readily separated from or combined with the features of any of the other several embodiments without departing from the scope or spirit of the various embodiments. All such modifications are intended to be within the scope of claims associated with this disclosure.

### Example 1

### Training Data, Training a Machine Learning Model, and Testing the Trained Machine Learning Model

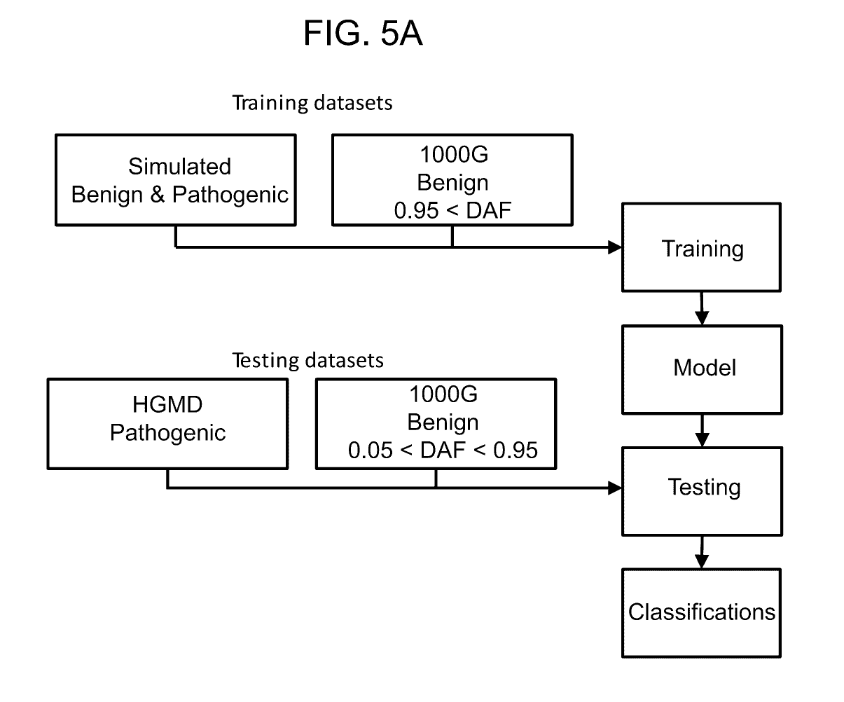

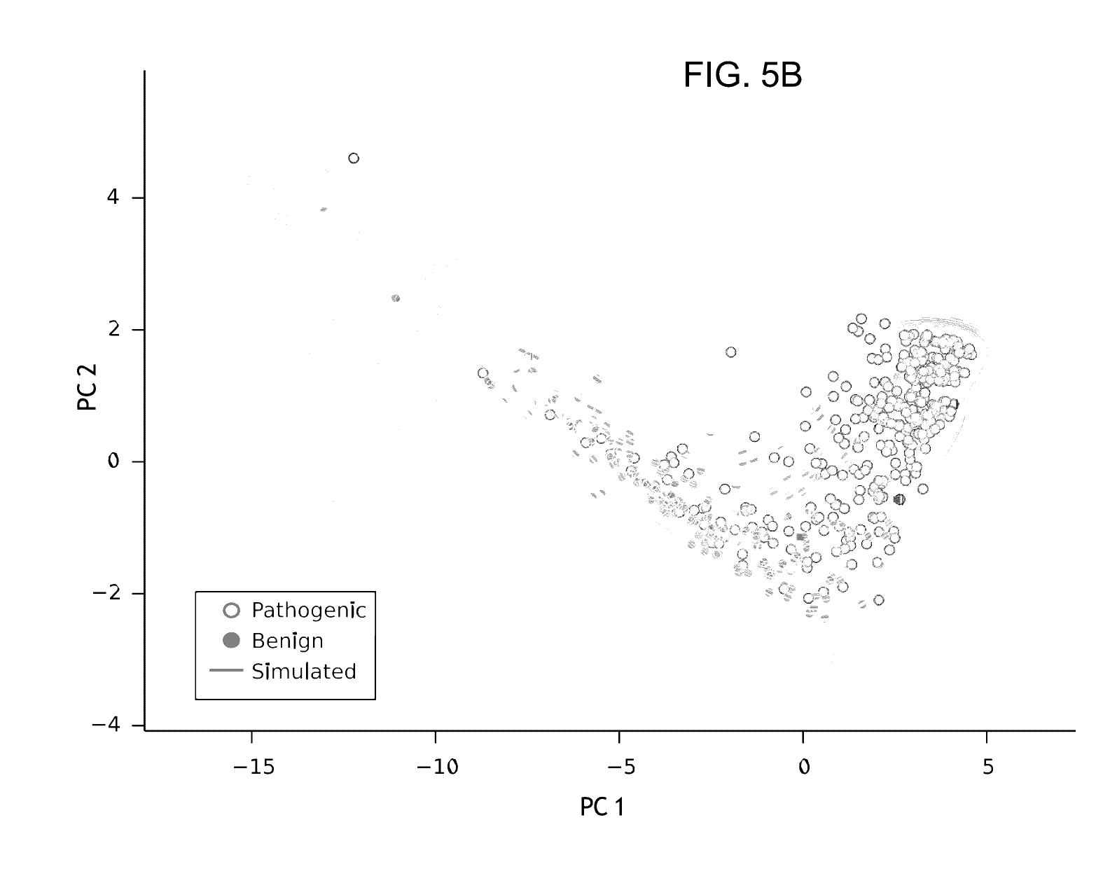

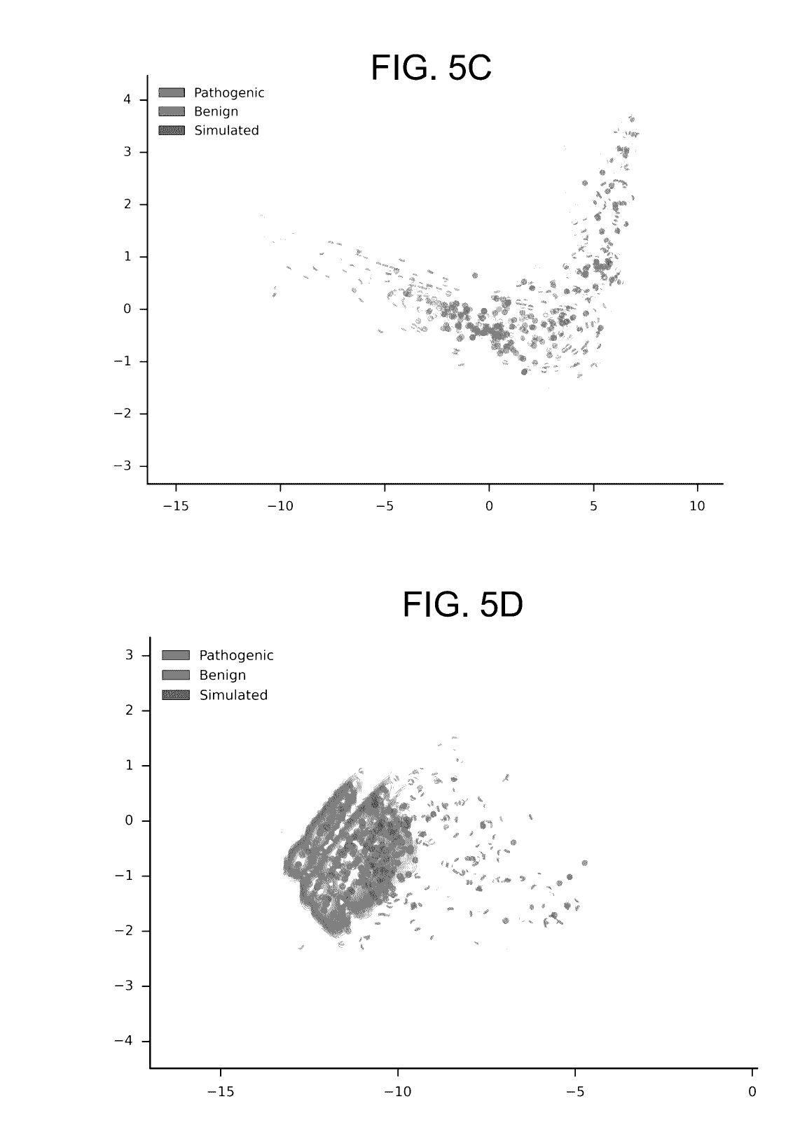

FIG. 5A illustrates one exemplary embodiment of the present invention. At an electronic device having at least one processor and memory, a machine learning model is trained based on training data. The training data comprises a labeled benign genetic sequence variant data set and an unlabeled genetic sequence variant data set. As illustrated in FIG. 5A, the labeled benign data set was obtained from the 1000 Genomics project by filtering the database for genetic sequence variants with a derived allele frequency (DAF) greater than 95%, which are assumed to be benign due to their high frequency. The labeled benign data set had 881,924 genetic sequence variants. The unlabeled genetic sequence variant data set was simulated using CADD's variant simulation software, which mutates a locus according to local mutation rates in a sliding 1.1 Mb window. The mutation rates were obtained by comparing the human genome to an inferred human-chimpanzee ancestor and bases were changed according to a genome-wide substitution matrix. The unlabeled genetic sequence variant data set had 1,405,358 genetic sequence variants and was assumed to be a mixture of benign genetic sequence variants and pathogenic genetic sequence variants. The labeled benign genetic sequence variant data set and the unlabeled genetic sequence variant data set was annotated by the features listed in Table 1. The annotated training data then trained a machine learning model as described herein (labeled “Training” in FIG. 5A). By treating the simulated genetic sequence variants as unlabeled data, the machine learning model learns the distributions of benign genetic sequence variants and pathogenic genetic sequence variants without needing an explicit pathogenic genetic sequence variant training data set. In FIG. 5B, the unlabeled genetic sequence variant is plotted as a kernel density (using contour lines) projected as the top two principal components of the learning model (using principal component analysis (PCA)).

As further illustrated in FIG. 5A, to test the trained machine learning model a genetic sequence variant testing data set was sorted into pathogenic cluster and benign clusters. The genomic sequence variant testing data set comprised a known pathogenic sequence variant testing data set and a known benign sequence variant testing data set. As illustrated in FIG. 5A, the known pathogenic sequence variant testing data set was obtained from the Human Gene Mutation Database (HGMD) (2013.2, Professional Edition, described in Stenson et al., Human mutation, 21(6):577-81 (2003)). The known benign sequence variant testing data set was obtained by filtering genomic sequence variants from the 1000 Genomes Project (1000G) filtered by derived allele frequency of <0.95 and ≧0.05. The trained machine learning model then assigned the known pathogenic genetic sequence variant data set and the known benign genetic sequence variants. As illustrated in FIG. 5B, a random subset of genetic sequence variants from both the known benign genetic sequence variant data set and known pathogenic genetic sequence variant data sets were plotted and are well separated in distinct clusters. Similarly, when a subset of randomly simulated non-canonical splice genetic sequence variants (FIG. 5C) or a subset of randomly simulated intergenic, regulator, or intronic genetic sequence variants (FIG. 5D) are plotted, well separated and distinct clusters or sub-clusters are observed.

### Example 2

### Comparison of the Semi-Supervised Clustering of Mutations Machine Learning Model to Previous Methods

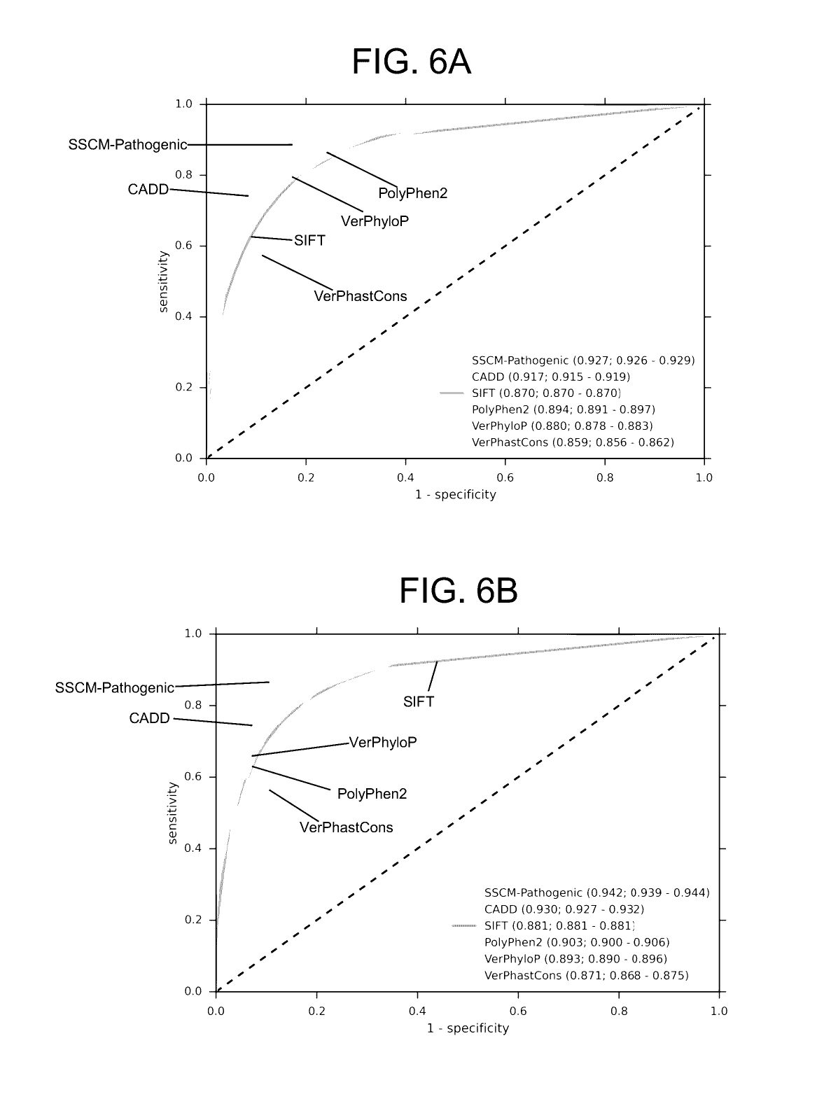

The methods described herein perform better at predicting pathogenicity of sequence variants compared to previously known methods. The performance of one embodiment of the method described herein, labeled in the FIGS. 6A, 6B, 7A, 7B, 8, and 10 and described herein as “SSCM-Pathogenic,” was compared to known methods of generating genetic sequence variant pathogenicity scores including CADD (described in Kircher et al., Nature Genetics, 46(3):310-5 (2014)) and other known methods.

As a proof of concept of one embodiment of the method described herein, a genetic sequence variant testing data set was sorted into a pathogenic cluster and a benign cluster. The genetic sequence variant testing data set comprised a known pathogenic genetic sequence variant testing data set and a known benign genetic sequence variant testing data set. Solely by way of example, the known pathogenic genetic sequence variant testing data set was obtained from HGMD or the ClinVar database (as of February 2014, described in Baker, Nature, 491(7423):171 (2012)). Solely by way of example, the benign genetic sequence variant testing data set was obtained by filtering genomic sequence variants from the 1000G filtered by derived allele frequency of <0.95 and ≧0.05. In another example, the benign sequence variant testing data set can be obtained from the loss-of-function (LoF)-tolerant genetic sequence variants described in MacArthur et al., Science, 335(6070):823-8 (2012).

Area-under-the-curve (AUC) values for the receiver operator characteristics (ROCs) for embodiments of the method described herein (e.g., SSCM-Pathogenic) compared to other methods demonstrates the high performance of the presently disclosed method. The ROCs demonstrate heightened specificity and sensitivity of the present methods. Table 2 summarizes a comparison of AUC values for ROCs of SSCM-Pathogenic and CADD on various variant classes including missense SNPs genetic sequence variants, and noncanonical splice altering genetic sequence variants. As can be seen in Table 2, SSCM-Pathogenic outperforms CADD in each of the tested genetic sequence variants for each tested database.

TABLE 2
Area-under-the-curve (AUC) values for the receiver operator
characteristics (ROCs) of SSCM-Pathogenic and CADD on
various genetic sequence variant classes. Benign
genetic sequence variants are either from the 1000G database
as described (n = 7,633,050). Pathogenic genetic sequence
variants are either from HGMD (n = 150,460) or ClinVar (n = 47,007).

| | | | SSCM- | |
|---|---|---|---|---|
| | Pathogenic | Benign | Pathogenic | CADD |
| Variant Class | Database | Database | AUC Score | AUC Score |
| Missense | HGMD | 1000G | 0.927 | 0.917 |
| Missense | ClinVar | 1000G | 0.942 | 0.930 |
| Noncanonical | HGMD | 1000G | 0.914 | 0.850 |
| Splice | | | | |
| Noncanonical | ClinVar | 1000G | 0.936 | 0.883 |
| Splice | | | | |

Missense Variants.

Missense variants can disrupt protein function, but are not always pathogenic or always benign. The methods disclosed herein are better able to distinguish pathogenic missense genetic sequence variants from benign missense genetic sequence variants. As illustrated in FIGS. 6A and 6B, and further presented in Table 3, one embodiment of the methods disclosed herein (e.g., SSCM-Pathogenic) performed better than CADD, SIFT, PolyPhen2, VerpHyloP and VerPhastCons at distinguishing pathogenic missense genetic sequence variants (obtained from HGMD (n=63,363; FIG. 6A) or ClinVar (n=18,783; FIG. 6B)) from benign missense genetic sequence variants (obtained from 1000G (n=20,133)) as determined by AUC values for the receiver operator characteristics.

TABLE 3
Area-under-the-curve (AUC) values for the receiver operator
characteristics (ROCs) of SSCM-Pathogenic and other
methods for the categorization of missense variants. 95%
confidence intervals for the AUCs were generated by dataset
bootstrap sampling.

| | HGMD | ClinVar |
|---|---|---|
| | AUC (95% | AUC (95% |
| Method | Confidence Interval) | Confidence Interval) |
| SSCM-Pathogenic | 0.927 (0.926-0.929) | 0.942 (0.939-0.944) |
| CADD | 0.917 (0.915-0.919) | 0.930 (0.927-0.932) |
| SIFT | 0.870 (0.870-0.870) | 0.881 (0.881-0.881) |
| PolyPhen2 | 0.894 (0.891-0.897) | 0.903 (0.900-0.906) |
| VerPhyloP | 0.880 (0.878-0.883) | 0.893 (0.890-0.896) |
| VerPhastCons | 0.859 (0.856-0.862) | 0.871 (0.868-0.875) |

Noncanonical Splice Variants.

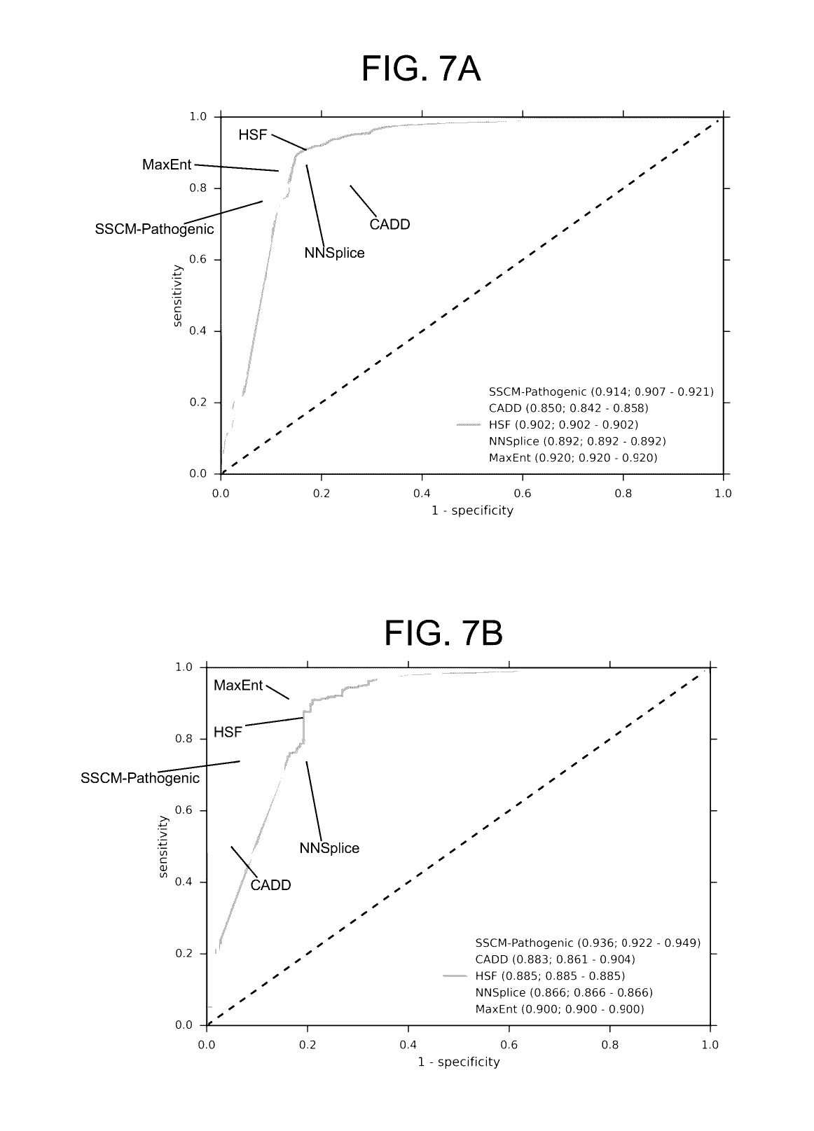

The methods disclosed herein are better able to distinguish pathogenic noncanonical splice genetic sequence variants from benign noncanonical splice genetic sequence variants. As illustrated in FIGS. 7A and 7B, and further presented in Table 4, one embodiment of the methods disclosed herein (e.g., SSCM-Pathogenic) performed better than CADD, HSF, NNSplice, and MaxEnt at distinguishing pathogenic noncanonical splice genetic sequence variants (obtained from HGMD (n=2,658; FIG. 7A) or ClinVar (n=290; FIG. 7B)) from benign noncanonical splice genetic sequence variants (obtained from 1000G (n=6,158)) as determined by AUC values for the receiver operator characteristics.

TABLE 4
Area-under-the-curve (AUC) values for the receiver operator
characteristics (ROCs) of SSCM-Pathogenic and other
methods for the categorization of noncanonical splice
variants. 95% confidence intervals for the AUCs were
generated by dataset bootstrap sampling.

| | HGMD | ClinVar |
|---|---|---|
| | AUC (95% | AUC (95% |
| Method | Confidence Interval) | Confidence Interval) |
| SSCM-Pathogenic | 0.914 (0.907-0.921) | 0.936 (0.922-0.949) |
| CADD | 0.850 (0.842-0.858) | 0.883 (0.861-0.904) |
| HSF | 0.902 (0.902-0.902) | 0.885 (0.885-0.885) |
| NNSplice | 0.892 (0.892-0.892) | 0.866 (0.866-0.866) |
| MaxEnt | 0.920 (0.920-0.920) | 0.900 (0.900-0.900) |

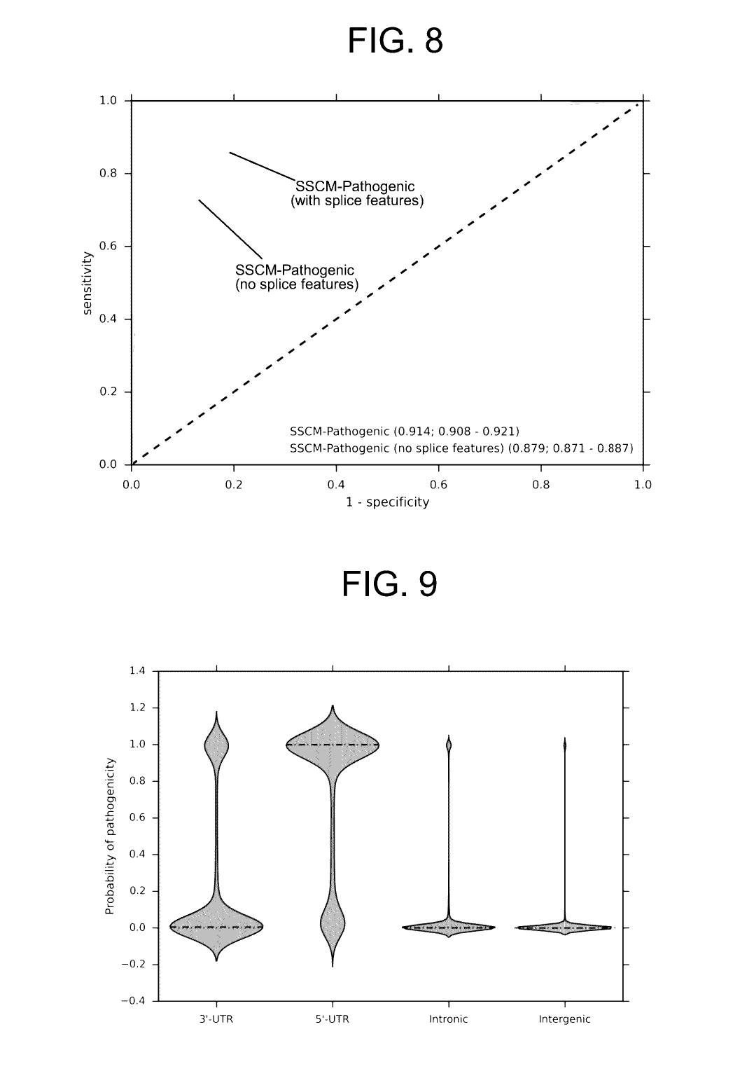

The high performance of the exemplary method (e.g., SSCM-Pathogenic) in distinguishing pathogenic noncanonical splice genetic sequence variants from benign noncanonical splice genetic sequence variants may be due, in part, to the inclusion and proper weighting of splicing scores in combination with evolutionary conservation scores in this exemplary model. FIG. 8 illustrates the performance differential of two exemplary methods of the present invention, which includes or does not include splicing features.

Noncoding Regions.

Predicting pathogenicity of genetic sequence variants in noncoding regions has been particularly challenging for prior methods. In some embodiments of the methods described herein, the method annotates a genetic sequence variant using one or more ENCODE features. ENCODE features are designed to predict active enhancer or promoter regions, where a mutation can result in pathogenic genetic sequence variants. Example ENCODE features include H3K27Ac, H3K4Me3, and H3K4Me.

In some embodiments of the methods disclosed herein (e.g., SCCM-Pathogenic), pathogenicity of a genetic sequence variant in noncoding regions is successfully predicted. In some embodiments, the methods described herein predicts pathogenicity of a genetic sequence variant in a 3′-UTR, 5′-UTR, intronic region, or intergenic region. These results are illustrated in FIG. 9.

### Example 3

### Comparison of Semi-Supervised Clustering of Mutations Machine Learning Model to a Supervised Machine Learning Model

One exemplary embodiment of the methods disclosed herein (e.g., SSCM-Pathogenic) was compared to a supervised machine learning model. The supervised machine learning model used the same features as the exemplary model, but the supervised machine learning model was trained using a labeled benign genetic sequence variant training data set (obtained from 1000G (n=20,133)) and a labeled pathogenic genetic sequence variant training data set (obtained from HGMD (n=63,363)). In contrast, the exemplary machine learning model (SSCM-Pathogenic) was trained using a labeled benign genetic sequence variant training data set and an unlabeled genetic sequence variant data set comprising a mixture of benign genetic sequence variants and pathogenic genetic sequence variants.

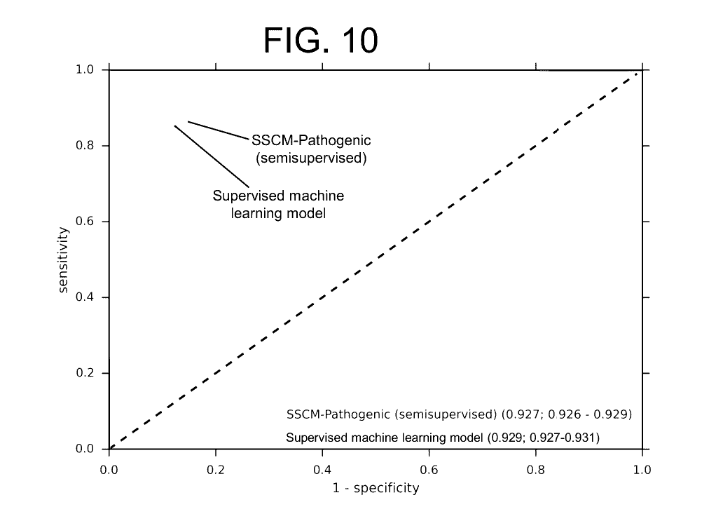

To test the supervised machine learning model and the exemplary model (SSCM-Pathogenic), the models were tested using a genetic sequence variant testing data set including ClinVar missense genetic sequence variants and splice genetic sequence variants. Because of the overall similarity between the ClinVar genetic sequence variants and the HGMD pathogenic genetic sequence variants used during training, it was expected that this training model would perform as well as, or marginally better than, the exemplary model (SSCM-Pathogenic). FIG. 10 illustrates these results.

Further examination of the supervised model revealed distributions with lower variance and more extreme scores, typical of overfitting. This further demonstrates overfitting as an inherent problem with training a supervised machine training model with a training data set similar to the testing data set.

### EXEMPLARY EMBODIMENTS

The following are exemplary embodiments of the present invention:

### Embodiment 1

A computer-implemented method for predicting pathogenicity of a test genetic sequence variant, the method comprising:

at an electronic device having at least one processor and memory:

(a) receiving training data comprising:

a first data set comprising labeled benign genetic sequence variants, and

a second data set comprising unlabeled genetic sequence variants, the unlabeled genetic sequence variants comprising a mixture of benign genetic sequence variants and pathogenic genetic sequence variants;

(b) annotating each genetic sequence variant in the first data set and the second data set with one or more features;

(c) training a machine learning model based on the training data, wherein the machine learning model is trained in a semi-supervised process;

(d) annotating the test genetic sequence variant with the one or more features; and

(e) predicting a probability that the test genetic sequence variant is pathogenic based on the machine learning model after training.

### Embodiment 2

A computer-implemented method for predicting pathogenicity of a test genetic sequence variant, the method comprising:

at an electronic device having at least one processor and memory:

(a) training a machine learning model based on training data, wherein the machine learning model is trained in a semi-supervised process, and the training data comprises:

a first data set comprising labeled benign genetic sequence variants, and

a second data set comprising unlabeled genetic sequence variants, the unlabeled genetic sequence variants comprising a mixture of benign genetic sequence variants and pathogenic genetic sequence variants;

wherein each variant in the first data set and the second data set is annotated with one or more features;

(b) annotating the test genetic sequence variant with the one or more features; and

(c) predicting a probability that the test genetic sequence variant is pathogenic based on the machine learning model after training.

### Embodiment 3

A method for predicting pathogenicity of a test genetic sequence variant, the method comprising:

(a) training a machine learning model based on training data, wherein the machine learning model is trained in a semi-supervised process, and the training data comprises:

a first data set comprising labeled benign genetic sequence variants, and

a second data set comprising unlabeled genetic sequence variants, the unlabeled genetic sequence variants comprising a mixture of benign genetic sequence variants and pathogenic genetic sequence variants;

wherein each variant in the first data set and the second data set is annotated with one or more features;

(b) annotating the test genetic sequence variant with the one or more features; and

(c) predicting a probability that the test genetic sequence variant is pathogenic based on the machine learning model after training.

### Embodiment 4

A method for predicting pathogenicity of a test genetic sequence variant, the method comprising:

(a) annotating the test genetic sequence variant with one or more features; and

(b) predicting a probability that the test genetic sequence variant is pathogenic based on a trained machine learning model, wherein the machine learning model is trained based on training data in a semi-supervised processes, and the training data comprises:

a first data set comprising labeled benign genetic sequence variants, and

a second data set comprising unlabeled genetic sequence variants, the unlabeled genetic sequence variants comprising a mixture of benign genetic sequence variants and pathogenic genetic sequence variants;

wherein each genetic sequence variant in the first data set and the second data set are annotated with one or more features.

### Embodiment 5

A method for predicting pathogenicity of a test genetic sequence variant, the method comprising:

(a) training a learning model based on training data, wherein the learning model is trained in a semi-supervised process, and the training data comprises:

a first data set comprising labeled benign genetic sequence variants, and

a second data set comprising unlabeled genetic sequence variants, the unlabeled genetic sequence variants comprising a mixture of benign genetic sequence variants and pathogenic genetic sequence variants;

wherein each variant in the first data set and the second data set is annotated with one or more features;

(b) annotating the test genetic sequence variant with the one or more features; and

(c) predicting a probability that the test genetic sequence variant is pathogenic based on the learning model after training.

### Embodiment 6

A method for predicting pathogenicity of a test genetic sequence variant, the method comprising:

(a) annotating the test genetic sequence variant with one or more features; and

(b) predicting a probability that the test genetic sequence variant is pathogenic based on a trained learning model, wherein the learning model is trained based on training data in a semi-supervised processes, and the training data comprises:

a first data set comprising labeled benign genetic sequence variants, and

a second data set comprising unlabeled genetic sequence variants, the unlabeled genetic sequence variants comprising a mixture of benign genetic sequence variants and pathogenic genetic sequence variants;

wherein each genetic sequence variant in the first data set and the second data set are annotated with one or more features.

### Embodiment 7

The method of any one of embodiments 1-6, further comprising generating the training data.

### Embodiment 8

The method of any one of embodiments 1-7, wherein the machine learning model does not comprise a support vector machine.

### Embodiment 9

The method of any one of embodiments 1-8, wherein the machine learning model comprises a generative model.

### Embodiment 10

The method of embodiment 9, wherein the generative model is a generative mixture model.

### Embodiment 11

The method of embodiment 9 or 10, wherein the generative model relies on one or more probability distributions specified by the one or more features.

### Embodiment 12

The method of any one of embodiments 1-11, wherein the one or more features comprise conditionally independent probability distributions.

### Embodiment 13

The method of embodiment 11 or 12, wherein the one or more probability distributions comprise a plurality of nodes, the nodes comprising discrete features or continuous features, wherein the discrete features comprise a Dirichlet conditionally independent probability distribution and the continuous features comprise a Gaussian conditionally independent probability distribution.

### Embodiment 14

The method of any one of embodiments 1-13, wherein the machine learning model comprises a discriminative model.

### Embodiment 15

The method of any one of embodiments 1-14, wherein the semi-supervised process is performed by expectation-maximization.

### Embodiment 16

The method of any one of embodiments 1-15, wherein the training comprises assigning each genetic sequence variant in the training data to a benign cluster or a pathogenic cluster.

### Embodiment 17

The method of embodiment 16, wherein the training comprises:

fixing one or more learning parameters for the benign clusters after n number of rounds of training; and

allowing one or more learning parameters for the pathogenic clusters to vary for (n+x) rounds of training;

wherein n and x are positive integers.

### Embodiment 18

The method of embodiment 17, wherein the one or more learning parameters for the benign clusters are fixed after one round of training.

### Embodiment 19

The method of any one of embodiments 1-18, wherein the machine learning model assigns the test genetic sequence variant to a benign cluster or a pathogenic cluster.

### Embodiment 20

The method of any one of embodiments 16-19, wherein the benign cluster comprises a plurality of benign sub-clusters.

### Embodiment 21

The method of any one of embodiments 16-20, wherein the pathogenic cluster comprises a plurality of pathogenic sub-clusters.

### Embodiment 22

The method of any one of embodiments 1-21, wherein the labeled benign genetic sequence variants have an allele frequency greater than 90% in a selected population.

### Embodiment 23

The method of any one of embodiments 1-22, wherein the unlabeled genetic sequence variants are simulated genetic sequence variants.

### Embodiment 24

The method of any one of embodiments 1-23, wherein the test genetic sequence variant is a human genetic sequence variant.

### Embodiment 25

The method of any one of embodiments 1-24, wherein the one or more features comprise a feature defined on an evolutionary conservation score, a missense variant score, an insertion variant score, a deletion variant score, a splice-site variant scores, or a regulatory score.

### Embodiment 26

The method of any one of embodiments 1-25, wherein the test genetic sequence variant comprises a missense genetic sequence variant, a nonsense genetic sequence variant, a splice-site genetic sequence variant, an insertion genetic sequence variant, a deletion genetic sequence variant, or a regulatory element genetic sequence variant.

### Embodiment 27

The method of any one of embodiments 1-26, wherein the training data comprises a missense genetic sequence variant, a nonsense genetic sequence variant, a splice-site genetic sequence variant, an insertion genetic sequence variant, a deletion genetic sequence variant, or a regulatory element genetic sequence variant.

### Embodiment 28

A non-transitory computer-readable storage medium comprising computer-executable instructions for carrying out any of the embodiments 1-27.

### Embodiment 29

A system comprising:

one or more processors;

memory; and

one or more programs, wherein the one or more programs are stored in the memory and configured to be executed by the one or more processors, the one or more programs including instructions for carrying out any of the embodiments 1-28.

What is claimed is:

1. A computer-implemented method for predicting pathogenicity of a test genetic sequence variant, the method comprising:
at an electronic device having at least one processor and memory:
(a) receiving training data comprising:
a first data set comprising labeled benign genetic sequence variants, and
a second data set comprising unlabeled genetic sequence variants, the unlabeled genetic sequence variants comprising a mixture of benign genetic sequence variants and pathogenic genetic sequence variants;
(b) annotating each genetic sequence variant in the first data set and the second data set with one or more features;
(c) training a machine learning model based on the training data, wherein the machine learning model is trained in a semi-supervised process;
(d) annotating the test genetic sequence variant with the one or more features; and
(e) predicting a probability that the test genetic sequence variant is pathogenic based on the machine learning model after training.

2. A computer-implemented method for predicting pathogenicity of a test genetic sequence variant, the method comprising:
at an electronic device having at least one processor and memory:
(a) training a machine learning model based on training data, wherein the machine learning model is trained in a semi-supervised process, and the training data comprises:
a first data set comprising labeled benign genetic sequence variants, and
a second data set comprising unlabeled genetic sequence variants, the unlabeled genetic sequence variants comprising a mixture of benign genetic sequence variants and pathogenic genetic sequence variants;
wherein each variant in the first data set and the second data set is annotated with one or more features;
(b) annotating the test genetic sequence variant with the one or more features; and
(c) predicting a probability that the test genetic sequence variant is pathogenic based on the machine learning model after training.

3. A method for predicting pathogenicity of a test genetic sequence variant, the method comprising:
(a) training a machine learning model based on training data, wherein the machine learning model is trained in a semi-supervised process, and the training data comprises:
a first data set comprising labeled benign genetic sequence variants, and
a second data set comprising unlabeled genetic sequence variants, the unlabeled genetic sequence variants comprising a mixture of benign genetic sequence variants and pathogenic genetic sequence variants;
wherein each variant in the first data set and the second data set is annotated with one or more features;
(b) annotating the test genetic sequence variant with the one or more features; and
(c) predicting a probability that the test genetic sequence variant is pathogenic based on the machine learning model after training.

4. A method for predicting pathogenicity of a test genetic sequence variant, the method comprising:
(a) annotating the test genetic sequence variant with one or more features; and
(b) predicting a probability that the test genetic sequence variant is pathogenic based on a trained machine learning model, wherein the machine learning model is trained based on training data in a semi-supervised processes, and the training data comprises:
a first data set comprising labeled benign genetic sequence variants, and
a second data set comprising unlabeled genetic sequence variants, the unlabeled genetic sequence variants comprising a mixture of benign genetic sequence variants and pathogenic genetic sequence variants;
wherein each genetic sequence variant in the first data set and the second data set are annotated with one or more features.

5. A method for predicting pathogenicity of a test genetic sequence variant, the method comprising:
(a) training a learning model based on training data, wherein the learning model is trained in a semi-supervised process, and the training data comprises:
a first data set comprising labeled benign genetic sequence variants, and
a second data set comprising unlabeled genetic sequence variants, the unlabeled genetic sequence variants comprising a mixture of benign genetic sequence variants and pathogenic genetic sequence variants;
wherein each variant in the first data set and the second data set is annotated with one or more features;
(b) annotating the test genetic sequence variant with the one or more features; and
(c) predicting a probability that the test genetic sequence variant is pathogenic based on the learning model after training.

6. A method for predicting pathogenicity of a test genetic sequence variant, the method comprising:
(a) annotating the test genetic sequence variant with one or more features; and
(b) predicting a probability that the test genetic sequence variant is pathogenic based on a trained learning model, wherein the learning model is trained based on training data in a semi-supervised processes, and the training data comprises:
a first data set comprising labeled benign genetic sequence variants, and
a second data set comprising unlabeled genetic sequence variants, the unlabeled genetic sequence variants comprising a mixture of benign genetic sequence variants and pathogenic genetic sequence variants;
wherein each genetic sequence variant in the first data set and the second data set are annotated with one or more features.

7. The method of any one of claims 1-6, further comprising generating the training data.

8. The method of any one of claims 1-7, wherein the machine learning model does not comprise a support vector machine.

9. The method of any one of claims 1-8, wherein the machine learning model comprises a generative model.

10. The method of claim 9, wherein the generative model is a generative mixture model.

11. The method of claim 9 or 10, wherein the generative model relies on one or more probability distributions specified by the one or more features.

12. The method of any one of claims 1-11, wherein the one or more features comprise conditionally independent probability distributions.

13. The method of claim 11 or 12, wherein the one or more probability distributions comprise a plurality of nodes, the nodes comprising discrete features or continuous features, wherein the discrete features comprise a Dirichlet conditionally independent probability distribution and the continuous features comprise a Gaussian conditionally independent probability distribution.

14. The method of any one of claims 1-13, wherein the machine learning model comprises a discriminative model.

15. The method of any one of claims 1-14, wherein the semi-supervised process is performed by expectation-maximization.

16. The method of any one of claims 1-15, wherein the training comprises assigning each genetic sequence variant in the training data to a benign cluster or a pathogenic cluster.

17. The method of claim 16, wherein the training comprises:
fixing one or more learning parameters for the benign clusters after n number of rounds of training; and
allowing one or more learning parameters for the pathogenic clusters to vary for (n+x) rounds of training;
wherein n and x are positive integers.

18. The method of claim 17, wherein the one or more learning parameters for the benign clusters are fixed after one round of training.

19. The method of any one of claims 1-18, wherein the machine learning model assigns the test genetic sequence variant to a benign cluster or a pathogenic cluster.

20. The method of any one of claims 16-19, wherein the benign cluster comprises a plurality of benign sub-clusters.

21. The method of any one of claims 16-20, wherein the pathogenic cluster comprises a plurality of pathogenic sub-clusters.

22. The method of any one of claims 1-21, wherein the labeled benign genetic sequence variants have an allele frequency greater than 90% in a selected population.

23. The method of any one of claims 1-22, wherein the unlabeled genetic sequence variants are simulated genetic sequence variants.

24. The method of any one of claims 1-23, wherein the test genetic sequence variant is a human genetic sequence variant.

25. The method of any one of claims 1-24, wherein the one or more features comprise a feature defined on an evolutionary conservation score, a missense variant score, an insertion variant score, a deletion variant score, a splice-site variant scores, or a regulatory score.

26. The method of any one of claims 1-25, wherein the test genetic sequence variant comprises a missense genetic sequence variant, a nonsense genetic sequence variant, a splice-site genetic sequence variant, an insertion genetic sequence variant, a deletion genetic sequence variant, or a regulatory element genetic sequence variant.

27. The method of any one of claims 1-26, wherein the training data comprises a missense genetic sequence variant, a nonsense genetic sequence variant, a splice-site genetic sequence variant, an insertion genetic sequence variant, a deletion genetic sequence variant, a regulatory element genetic sequence variant, or a combination thereof.

28. A non-transitory computer-readable storage medium comprising computer-executable instructions for carrying out any of the claims 1-27.

29. A system comprising:
one or more processors;
memory; and
one or more programs, wherein the one or more programs are stored in the memory and configured to be executed by the one or more processors, the one or more programs including instructions for carrying out any of the claims 1-28.
